(19) United States
(12) Patent Application Publication
(10) Pub. No.: US 2020/0245235 A1
(43) Pub. Date: Jul. 30, 2020

(54) METHOD FOR SELECTING NON-PUBLIC NETWORK IN WIRELESS COMMUNICATION SYSTEM AND APPARATUS THEREOF

(71) Applicant: LG Electronics Inc., Seoul (KR)

(72) Inventor: Sungduck Chun, Seoul (KR)

(21) Appl. No.: 16/750,877

(22) Filed: Jan. 23, 2020

Related U.S. Application Data
(60) Provisional application No. 62/796,574, filed on Jan. 24, 2019.

(30) Foreign Application Priority Data
Jan. 30, 2019 (KR) 10-2019-0011935

(51) Int. Cl. H04W 48/18; H04W 60/00

(52) U.S. Cl. CPC H04W 48/18; H04W 60/00

(57) ABSTRACT

The present specification, in a method for a user equipment (UE) to select a non-public network (NPN) in a wireless communication system, may comprise the steps of: selecting a network based on a network selection list stored in the UE or an USIM of the UE, the network selection list including (i) a PLMN identifier (ii) or the PLMN identifier and an NPN identifier; when the network selection list includes the PLMN identifier and the NPN identifier and the selected network is an NPN associated with the NPN identifier, transmitting a registration request message to the NPN; and receiving a registration response message from the NPN in response to the registration request message.

### BACKGROUND OF THE INVENTION

### Field of the invention

The present specification relates to a method for supporting a dedicated network for specific users, such as a smart factory and an enterprise user, and to a communication system and a method for a UE to efficiently and power-efficiently select a dedicated network and a public network, thereby ensuring a quality and stability of a communication service.

### Related Art

In a wireless communication system, mobile communication systems have been developed to provide voice services while ensuring activity and mobility of users. However, coverage of mobile communication systems has been extended to include data services, as well as voice services, resulting in an explosive increase in traffic and shortage of resources. To meet the demands of users expecting relatively high speed services, an advanced mobile communication system is required.

Requirements of a next-generation mobile communication system include accommodation of increased amounts of data traffic, a significant increase in a transfer rate per user terminal, accommodation of considerably increased number of connection devices, very low end-to-end latency, and high energy efficiency. To this end, there have been researched various technologies such as dual connectivity, massive multiple input multiple output (MIMO), in-band full duplex, non-orthogonal multiple access (NOMA), super wideband, device networking, and the like.

### SUMMARY OF THE INVENTION

An aspect of the present specification, in a method for a user equipment (UE) to select a non-public network (NPN) in a wireless communication system, the method may comprise the steps of: selecting a network based on a network selection list stored in the UE or an USIM of the UE, the network selection list including (i) a PLMN identifier (ii) or the PLMN identifier and an NPN identifier; when the network selection list includes the PLMN identifier and the NPN identifier and the selected network is an NPN associated with the NPN identifier, transmitting a registration request message to the NPN; and receiving a registration response message from the NPN in response to the registration request message.

In addition, the selected network may be a network having the highest priority based on a network which has not attempted registration included in the network selection list.

In addition, in the network selection list, (i) the PLMN identifier (ii) or the PLMN identifier and the NPN identifier may be aligned based on the priority.

In addition, the network selection list may be a PLMN selector list.

In addition, the network selection list may further comprise radio access technology (RAT) information of a network associated with (i) the PLMN identifier (ii) or the PLMN identifier and the NPN identifier.

In addition, the method may further comprise the steps of selecting a PLMN associated with the PLMN identifier when the selected item includes only the PLMN identifier, based on the network selection list; transmitting a registration request message to the PLMN; and receiving a registration response message from the PLMN in response to the registration request message.

In addition, the network selection list may further include location information in which the NPN associated with the NPN identifier is valid.

In addition, wherein the selecting the network is performed when the current location of the UE is in a valid region where an NPN associated with the NPN identifier is available, based on the network selection list including the PLMN identifier and the NPN identifier.

In addition, the current location of the UE is determined using the tracking area (TA) information, cell information or GPS coordinate information set in the UE.

In addition, the method may further comprise the steps of performing a PLMN selection process based on absence of the selected network; transmitting a registration request message to the selected PLMN; and receiving, from the selected PLMN, a registration response message as a response to the registration request.

Another aspect of the present specification, in a user equipment (UE) performing a method to select a non-public network (NPN) in a wireless communication system, comprising: a transceiver; a USIM, a memory; and a proceesor may be configured to control the transceiver and the memory, the processor may select a network based on a network selection list stored in the memory or an USIM, the network selection list including (i) a PLMN identifier (ii) or the PLMN identifier and an NPN identifier; when the network selection list includes the PLMN identifier and the NPN identifier and the selected network is an NPN associated with the NPN identifier, transmit a registration request message to the NPN, and receive a registration response message from the NPN in response to the registration request message, through the transceiver.

### BRIEF DESCRIPTION OF THE DRAWINGS

The accompany drawings, which are included as part of the detailed description in order to help understanding of the present disclosure, provide embodiments of the present disclosure and describe the technical characteristics of the present disclosure along with the detailed description.

FIG. 1 illustrates an AI device 100 according to an embodiment of the present disclosure.

FIG. 2 illustrates an AI server 200 according to an embodiment of the present disclosure.

FIG. 3 illustrates an AI system 1 according to an embodiment of the present disclosure.

FIG. 4 illustrates various reference points.

FIG. 5 illustrates an example of a network structure of an evolved universal terrestrial radio access network (E-UTRAN) to which the present disclosure is applicable.

FIG. 6 illustrates an example of a general architecture of E-UTRAN and EPC.

FIG. 7 illustrates an example of a structure of a radio interface protocol in a control plane between a UE and eNB.

FIG. 8 illustrates an example of a structure of a radio interface protocol in a user plane between a UE and eNB.

FIG. 9 illustrates an architecture of a general NR-RAN.

FIG. 10 illustrates a functional separation of a general NG-RAN and 5GC.

FIG. 11 illustrates an example of a general architecture of 5G.

FIG. 12 is an embodiment of a UE to which the present specification can be applied.

FIG. 13 is an embodiment of a UE to which the present specification can be applied.

FIG. 14 illustrates a block configuration diagram of a communication device according to an embodiment of the present disclosure.

FIG. 15 illustrates a block configuration diagram of a communication device according to an embodiment of the present disclosure.

FIG. 16 illustrates a structure of a radio interface protocol in a control plane between a UE and eNodeB.

### DESCRIPTION OF EXEMPLARY EMBODIMENTS

Hereafter, various embodiments of the present disclosure will be described in detail with reference to the accompanying drawings. A detailed description to be disclosed below together with the accompanying drawing is to describe embodiments of the present disclosure and not to describe a unique embodiment for carrying out the present disclosure. The detailed description below includes details in order to provide a complete understanding. However, a person skilled in the art knows that the present disclosure can be carried out without the details.

In some cases, in order to prevent a concept of the present disclosure from being ambiguous, known structures and devices may be omitted or illustrated in a block diagram format based on core function of each structure and device.

In the present disclosure, a base station refers to a terminal node of a network directly communicating with a terminal. In some embodiments, a specific operation described as being performed by the base station may be performed by an upper node of the base station. That is, it is apparent that in the network consisting of multiple network nodes including the base station, various operations performed for communication with the terminal can be performed by the base station or network nodes other than the base station. A ‘base station (BS)’ may be generally substituted by terms such as a fixed station, Node B, evolved-NodeB (eNB), a base transceiver system (BTS), an access point (AP), and the like. Further, a ‘terminal’ may be fixed or movable and be substituted by terms such as user equipment (UE), a mobile station (MS), a user terminal (UT), a mobile subscriber station (MSS), a subscriber station (SS), an advanced mobile station (AMS), a wireless terminal (WT), a Machine-Type Communication (MTC) device, a Machine-to-Machine (M2M) device, a Device-to-Device (D2D) device, and the like.

Hereinafter, a downlink (DL) means communication from the base station to the terminal, and an uplink (UL) means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help the understanding of the present disclosure, and the specific terms may be modified into other forms within the scope without departing from the technical spirit of the present disclosure.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio

Service(GPRS)/Enhanced Data Rates for GSM Evolution (EDGE). The OFDMA may be implemented as radio technology such as IEEE 802.11(Wi-Fi), IEEE 802.16 (WiMAX), IEEE 802-20, E-UTRA (Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

Embodiments of the present disclosure may be supported by standard documents disclosed in at least one of IEEE 802, 3GPP, and 3GPP2 which are the wireless access systems. That is, steps or parts which are not described in embodiments of the present disclosure to definitely show the technical spirit of the present disclosure may be supported by the standard documents. Further, all terms disclosed in the present disclosure may be described in the standard documents.

3GPP LTE/LTE-A/NR is primarily described for clear description, but technical features of the present disclosure are not limited thereto.

Terms used in the present disclosure are defined as follows.

IP Multimedia Subsystem or IP Multimedia Core Network Subsystem (IMS): an architectural framework for providing standardization for delivering voice or other multimedia services on internet protocol (IP).

Universal Mobile Telecommunication System (UMTS): the 3rd generation mobile communication technology based on global system for mobile communication (GSM) developed by the 3GPP.

Evolved Packet System (EPS): a network system consisting of an evolved packet core (EPC), that is an IP based packet switched core network, and an access network such as LTE and UTRAN. The EPS is a network of an evolved version of a universal mobile telecommunications system (UMTS).

NodeB: a base station of a UMTS network. It is installed outdoor, and its coverage has a scale of a macro cell.

eNodeB: a base station of an EPS network. It is installed outdoor, and its coverage has a scale of a macro cell.

Home NodeB: it is installed indoors as a base station of the UMTS network, and its coverage has a scale of a macro cell.

Home eNodeB: it is installed indoors as a base station of the EPS network, and its coverage has a scale of a macro cell.

User Equipment (UE): the UE can be called a terminal, a mobile equipment (ME), a mobile station (MS), etc. The UE can be a portable device such as a notebook computer, a cellular phone, a personal digital assistant (PDA), a smart phone, and a multimedia device, or a fixed device such as a personal computer (PC) and a vehicle-mounted device. The term of UE may refer to an MTC UE in the description related to MTC.

Machine Type Communication (MTC): communication performed by machines without human intervention. It may be called Machine-to-Machine (M2M) communication.

MTC terminal (MTC UE or MTC device or MRT apparatus): a terminal (e.g., a vending machine, meter, etc.) having a communication function (e.g., communication with an MTC server over PLMN) over a mobile communication network and performing a MTC function.

Radio Access Network (RAN): a unit including a Node B and a radio network controller (RNC) controlling the Node B in the 3GPP network. The RAN exists at a UE end and provides a connection to a core network.

Home Location Register (HLR)/Home Subscriber Server (HSS): a database containing subscriber information within the 3GPP network. The HSS can perform functions such as configuration storage, identity management, user state storage, etc.

Public Land Mobile Network (PLMN): a network configured for the purpose of providing mobile communication services to individuals. The PLMN can be configured for each operator.

Non-Access Stratum (NAS): a functional layer for exchanging signalling and a traffic message between a UE and a core network at the UMTS and EPS protocol stacks. The NAS mainly functions to support mobility of the UE and support a session management procedure for establishing and maintaining an IP connection between the UE and PDN GW.

Service Capability Exposure Function (SCEF): an entity within the 3GPP architecture for service capability exposure that provides a means to safely expose the services and capabilities provided by 3GPP network interfaces.

Mobility Management Entity (MME): A network node in the EPS network which performs mobility management and session management functions.

Packet Data Network Gateway (PDN-GW): A network node in the EPS network which performs UE IP address allocation, packet screening and filtering, and charging data collection functions.

Serving GW (Serving Gateway): A network node in the EPS network which performs functions such as mobility anchor, packet routing, idle mode packet buffering, and triggering paging for the ME of MME.

Policy and Charging Rule Function (PCRF): A node in the EPS network which performs policy decision to dynamically apply differentiated QoS and billing policies for each service flow.

Open Mobile Alliance Device Management (OMA DM): A protocol designed to manage mobile devices, such as mobile phones, PDAs, and portable computers, which performs functions such as device configuration, firmware upgrade, and error report

Operation Administration and Maintenance (OAM): A network management function group which provides network fault indication, performance information, and data and diagnostic functions.

Packet Data Network (PDN): A network in which a server (e.g., MMS server, WAP server, etc.) supporting a specific service is located.

PDN connection: A connection from the UE to the PDN, i.e., the association (connection) between the UE represented by the IP address and the PDN represented by the APN.

EPS Mobility Management (EMM): a sublayer of the NAS layer, where the EMM may be in an “EMM-Registered” or “EMM-Deregistered” state depending on whether the UE is network attached or detached.

EMM Connection Management (ECM) connection: A signaling connection for the exchange of NAS messages, established between the UE and the MME. An ECM connection is a logical connection consisting of an RRC connection between the UE and an eNB and Si signaling connection between the eNB and the MME. When the ECM connection is established/terminated, the RRC and S1 signaling connections are established/terminated as well. To the UE, the established ECM connection means having an RRC connection established with the eNB, and to the MME, it means having an S1 signaling connection established with the eNB. Depending on whether the NAS signaling connection, i.e., the ECM connection is established, the ECM may have an “ECM-Connected” or “ECM-Idle” state.

Access-Stratum (AS): It includes a protocol stack between the UE and the radio (or access) network and is responsible for transmitting data and network control signals.

NAS configuration Management Object (MO): A management object (MO) used to configure the UE with parameters related to NAS functionality.

Packet Data Network (PDN): A network in which a server (e.g., multimedia messaging service (MMS) server, wireless application protocol (WAP) server, etc.) supporting a specific service is located.

PDN connection: a logical connection between the UE and the PDN, represented by one IP address (one IPv4 address and/or one IPv6 prefix).

Access Point Name (APN): a string that refers to or identifies a PDN. In order to access the requested service or network, it goes through a specific P-GW, which means a predefined name (string) in the network so that the P-GW can be found. (e.g., internet. mnc012.mcc345.gprs)

Access Network Discovery and Selection Function (ANDSF): it is a network entity and provides policies that allow the UE to discover and select an available access on a per operator basis.

EPC path (or infrastructure data path): a user plane communication path through EPC.

E-UTRAN Radio Access Bearer (E-RAB): it refers to the concatenation of a S1 bearer and a corresponding data radio bearer. If there is an E-RAB, there is an one-to-one mapping between the E-RAB and the EPS bearer of the NAS.

GPRS Tunneling Protocol (GTP): a group of IP-based communications protocols used to carry general packet radio service (GPRS) within GSM, UMTS and LTE networks. Within the 3GPP architecture, GTP and proxy mobile IPv6-based interfaces are specified on various interface points. GTP can be decomposed into several protocols (e.g., GTP-C, GTP-U and GTP′). GTP-C is used within a GPRS core network for signalling between gateway GPRS support nodes (GGSN) and serving GPRS support nodes (SGSN). GTP-C allows the SGSN to activate a session (e.g., PDN context activation), deactivate the same session, adjust the quality of service parameters, or renew a session for a subscriber, that has just operated from another SGSN, for the user. GTP-U is used to carry user data within the GPRS core network and between the radio access network and the core network. FIG. 1 illustrates a schematic structure of an evolved packet system (EPS) including an evolved packet core (EPC).

Cell as a radio resource: the 3GPP LTE/LTE-A system has used a concept of a cell to manage radio resources, and a cell related to the radio resource is distinguished from a cell of a geographic area. The “cell” related to the radio resource is defined as a combination of downlink (DL) resources and uplink (UL) resources, i.e., a combination of DL carriers and UL carriers. The cell may be configured with DL resource only or a combination of DL resources and UL resources. If carrier aggregation is supported, a linkage between a carrier frequency of the DL resource and a carrier frequency of the UL resource may be indicated by system information. Here, the carrier frequency refers to a center frequency of each cell or carrier. In particular, a cell operating on a primary frequency is called a primary cell or Pcell, and a cell operating on a secondary frequency is called a secondary cell or Scell. The Scell refers to a cell that can be configured after radio resource control (RRC) connection establishment is achieved and can be used for providing additional radio resources. Depending on capabilities of the UE, the Scell together with the Pcell can form a set of serving cells for the UE. For the UE that is in a RRC_CONNECTED state but is not configured with carrier aggregation, or does not support carrier aggregation, there is only one serving cell configured with only the Pcell. The “cell’ of the geographic area can be understood as a coverage in which a node can provide services using a carrier, and the “cell’ of the radio resource is related to a bandwidth (BW) that is a frequency range configured by the carrier. Since a downlink coverage that is a range within which the node can transmit a valid signal and an uplink coverage that is a range within which the node can receive the valid signal from the UE depend on the carrier carrying the corresponding signal, the coverage of the node is associated with the coverage of the “cell’ of the radio resource the node uses. Thus, the term “cell” may be used to sometimes denote the coverage of the service by the node, sometimes denote the radio resource, and sometimes denote a range that a signal using the radio resources can reach with a valid strength.

The EPC is a key element of system architecture evolution (SAE) to improve the performance of 3GPP technologies. The SAE corresponds to a research project to determine a network structure supporting mobility between various kinds of networks. The SAE aims to provide an optimized packet-based system, for example, supporting various radio access technologies on an IP basis and providing more improved data transfer capability.

More specifically, the EPC is a core network of an IP mobile communication system for the 3GPP LTE system and can support packet-based real-time and non-real time services. In the existing mobile communication system (i.e., in the 2nd or 3rd mobile communication system), functions of the core network have been implemented through two separate sub-domains including a circuit-switched (CS) sub-domain for voice and a packet-switched (PS) sub-domain for data. However, in the 3GPP LTE system that is an evolution of the 3rd mobile communication system, the CS and PS sub-domains have been unified into a single IP domain. That is, in the 3GPP LTE system, a connection between UEs having IP capabilities can be configured via an IP-based base station (e.g., evolved Node B (eNodeB)), an EPC, and an application domain (e.g., IP multimedia subsystem (IMS)). In other words, the EPC is an essential architecture to implement end-to-end IP services.

The EPC may include various components, and FIG. 1 illustrates some of the EPC components, including a serving gateway (SGW), a packet data network gateway (PDN GW), a mobility management entity (MME), a SGSN (serving GPRS (general packet radio service) supporting node), and an enhanced packet data gateway (ePDG).

The SGW (or S-GW) operates as a boundary point between a radio access network (RAN) and a core network, and is an element that functions to maintain a data path between the eNB and the PDN GW. Further, if the UE moves across areas served by the eNB, the SGW serves as a local mobility anchor point. That is, packets can be routed through the SGW for mobility within the E-UTRAN (evolved-universal mobile telecommunications system (UMTS) terrestrial radio access network defined in 3GPP Release-8 or later). The SGW may also serve as an anchor point for mobility with other 3GPP networks (RAN defined before 3GPP Release-8, for example, UTRAN or GERAN (global system for mobile communication (GSM)/enhanced data rates for global evolution (EDGE) radio access network).

The PDN GW (or P-GW) corresponds to a termination point of a data interface to a packet data network. The PDN GW can support policy enforcement features, packet filtering, charging support, and the like. In addition, the PDN GW can serve as an anchor point for mobility management between the 3GPP network and a non-3GPP network (e.g., untrusted networks such as an interworking wireless local area network (I-WLAN) or trusted networks such as a code division multiple access (CDMA) network and Wimax).

Hereinafter, the present disclosure is described based on the terms defined as above.

Three major requirement areas of 5G include (1) an enhanced mobile broadband (eMBB) area, (2) a massive machine type communication (mMTC) area, and (3) an ultra-reliable and low latency communications (URLLC) area.

Some use cases may require multiple areas for optimization, and other use case may be focused on only one key performance indicator (KPI). 5G supports these various use cases in a flexible and reliable method.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this can be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link with ultra reliability/low available latency, such as a self-driving vehicle. A level of reliability and latency is essential for smart grid control, industry automation, robot engineering, drone control and adjustment.

Multiple use cases are described in more detail below.

5G can supplement fiber-to-the-home (FTTH) and cable-based broadband (or DOCSIS) as means for providing a stream evaluated from several hundreds of mega bits per second to gigabits per second. Such fast speed is required to deliver TV with a resolution of 4K or more (6K, 8K or more) in addition to virtual reality and augmented reality. Virtual reality (VR) and augmented reality (AR) applications include immersive sports games. A specific application program may require a special network configuration. For example, for VR games, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between vehicles, information exchange between a vehicle and a supported infrastructure, and information exchange between a vehicle and other connected devices (e.g., devices accompanied by a pedestrian). A safety system guides alternative courses of a behavior so that a driver can drive more safely, thereby reducing a danger of an accident. A next stage will be a remotely controlled or self-driven vehicle. This requires very reliable, very fast communication between different self-driven vehicles and between an automotive and infra. In the future, a self-driving vehicle can perform all driving activities, and a driver will be focused on only abnormal traffics, which cannot be identified by a vehicle itself. Technical requirements of a self-driving vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system can support remote treatment providing clinical treatment at a distant place. This helps to reduce a barrier for the distance and can improve access to medical services which are not continuously used at remote farming areas. Furthermore, this is used to save life in important treatment and an emergency condition. A radio sensor network based on mobile communication can provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

Embodiments of the present disclosure to be described below can be implemented through the combination or the modification in order to meet the 5G requirements described above.

The following is described in detail in relation to the technical field to which embodiments of the present disclosure to be described below can be applied.

Artificial Intelligence (AI)

Artificial intelligence means the field in which artificial intelligence or methodology capable of producing artificial intelligence is researched. Machine learning means the field in which various problems handled in the artificial intelligence field are defined and methodology for solving the problems are researched. Machine learning is also defined as an algorithm for improving performance of a task through continuous experiences for the task.

An artificial neural network (ANN) is a model used in machine learning, and is configured with artificial neurons (nodes) forming a network through a combination of synapses, and may mean the entire model having a problem-solving ability. The artificial neural network may be defined by a connection pattern between the neurons of different layers, a learning process of updating a model parameter, and an activation function for generating an output value.

The artificial neural network may include an input layer, an output layer, and optionally one or more hidden layers. Each layer includes one or more neurons. The artificial neural network may include a synapse connecting neurons. In the artificial neural network, each neuron may output a function value of an activation function for input signals, weight, and a bias input through a synapse.

A model parameter means a parameter determined through learning, and includes the weight of a synapse connection and the bias of a neuron. Furthermore, a hyper parameter means a parameter that needs to be configured prior to learning in the machine learning algorithm, and includes a learning rate, the number of times of repetitions, a mini-deployment size, and an initialization function.

The purpose of learning of the artificial neural network may be considered to determine a model parameter that minimizes a loss function. The loss function may be used as an index for determining an optimal model parameter in the learning process of an artificial neural network.

Machine learning may be classified into supervised learning, unsupervised learning, and reinforcement learning based on a learning method.

Supervised learning means a method of training an artificial neural network in the state in which a label for learning data has been given. The label may mean an answer (or a result value) that must be deduced by an artificial neural network when learning data is input to the artificial neural network. Unsupervised learning may mean a method of training an artificial neural network in the state in which a label for learning data has not been given. Reinforcement learning may mean a learning method in which an agent defined within an environment is trained to select a behavior or behavior sequence that maximizes accumulated compensation in each state.

Machine learning implemented as a deep neural network (DNN) including a plurality of hidden layers, among artificial neural networks, is also called deep learning. Deep learning is part of machine learning. Hereinafter, machine learning is used as a meaning including deep learning.

Robot

A robot may mean a machine that automatically processes a given task or operates based on an autonomously owned ability. Particularly, a robot having a function for recognizing an environment and autonomously determining and performing an operation may be called an intelligent robot.

A robot may be classified for industry, medical treatment, home, and military based on its use purpose or field.

A robot includes a driver including an actuator or motor, and can perform various physical operations, such as moving a robot joint. Furthermore, a movable robot includes a wheel, a brake, a propeller, etc. in a driver, and may run on the ground or fly in the air through the driver.

Self-Driving (Autonomous-Driving)

Self-driving means a technology for autonomous driving. A self-driving vehicle means a vehicle that runs without user manipulation or by user's minimum manipulation.

For example, self-driving may include all of a technology for maintaining a driving lane, a technology for automatically controlling speed, such as adaptive cruise control, a technology for automatically driving along a fixed path, a technology for automatically setting a path when a destination is set and driving, and the like.

A vehicle includes all of a vehicle having only an internal combustion engine, a hybrid vehicle including both an internal combustion engine and an electric motor, and an electric vehicle having only an electric motor, and may include a train, a motorcycle, etc. in addition to the vehicles.

In this case, the self-driving vehicle may be considered as a robot having a self-driving function.

Extended Reality (XR)

Extended reality collectively refers to virtual reality (VR), augmented reality (AR), and mixed reality (MR). The VR technology provides an object or background of the real world as a CG image only. The AR technology provides a virtually produced CG image on an actual thing image. The MR technology is a computer graphics technology for mixing and combining virtual objects with the real world and providing them.

The MR technology is similar to the AR technology in that it shows a real object and a virtual object. However, in the AR technology, a virtual object is used to supplement a real object. In contrast, unlike in the AR technology, in the MR technology, a virtual object and a real object are used as the same character.

The XR technology can be applied to a head-mount display (HMD), a head-up display (HUD), a mobile phone, a tablet PC, a laptop, a desktop, TV, a digital signage, and the like. A device to which the XR technology is applied may be called an XR device.

FIG. 1 illustrates an AI device 100 according to an embodiment of the present disclosure.

The AI device 100 may be implemented as a fixed device or mobile device, such as TV, a projector, a mobile phone, a smartphone, a desktop computer, a notebook, a terminal for digital broadcasting, a personal digital assistants (PDA), a portable multimedia player (PMP), a navigator, a tablet PC, a wearable device, a set-top box (STB), a DMB receiver, a radio, a washing machine, a refrigerator, a desktop computer, a digital signage, a robot, and a vehicle.

Referring to FIG. 1, the terminal 100 may include a communication unit 110, an input unit 120, a learning processor 130, a sensing unit 140, an output unit 150, a memory 170, and a processor 180.

The communication unit 110 may transmit and receive data to and from external devices, such as other AI devices 100a to 100er or an AI server 200, using wired and wireless communication technologies. For example, the communication unit 110 may transmit and receive sensor information, a user input, a learning model, and a control signal to and from external devices.

Examples of communication technologies used by the communication unit 110 include a global system for mobile communication (GSM), code division multi access (CDMA), long term evolution (LTE), 5G, a wireless LAN (WLAN), wireless-fidelity (Wi-Fi), Bluetooth™, radio frequency identification (RFID), infrared data association (IrDA), ZigBee, near field communication (NFC), etc.

The input unit 120 may obtain various types of data.

The input unit 120 may include a camera for an image signal input, a microphone for receiving an audio signal, a user input unit for receiving information from a user, etc.

Herein, the camera or the microphone is treated as a sensor, and a signal obtained from the camera or the microphone may be called sensing data or sensor information.

The input unit 120 can obtain learning data for model learning and input data to be used when an output is obtained using a learning model. The input unit 120 can obtain not-processed input data. In this case, the processor 180 or the learning processor 130 can extract an input feature by performing pre-processing on the input data.

The learning processor 130 may be trained by a model configured with an artificial neural network using learning data. In this case, the trained artificial neural network may be called a learning model. The learning model may be used to deduce a result value of new input data not learning data, and the deduced value may be used as a base for performing a given operation.

The learning processor 130 can perform AI processing along with the learning processor 240 of the AI server 200.

The learning processor 130 may include a memory integrated or implemented in the AI device 100. Alternatively, the learning processor 130 may be implemented using the memory 170, an external memory directly coupled to the AI device 100, or a memory maintained in an external device.

The sensing unit 140 can obtain at least one of internal information of the AI device 100, surrounding environment information of the AI device 100, or user information using various sensors.

Examples of sensors included in the sensing unit 140 include a proximity sensor, an illumination sensor, an acceleration sensor, a magnetic sensor, a gyro sensor, an inertia sensor, an RGB sensor, an IR sensor, a fingerprint recognition sensor, an ultrasonic sensor, a photo sensor, a microphone, LIDAR, and a radar, etc.

The output unit 150 can generate an output related to a visual sense, an auditory sense or a tactile sense.

The output unit 150 may include a display for outputting visual information, a speaker for outputting auditory information, and a haptic module for outputting tactile information.

The memory 170 can store data supporting various functions of the AI device 100. For example, the memory 170 can store input data obtained by the input unit 120, learning data, a learning model, a learning history, etc.

The processor 180 can determine at least one executable operation of the AI device 100 based on information that is determined or generated using a data analysis algorithm or a machine learning algorithm. Furthermore, the processor 180 can perform the determined operation by controlling the components of the AI device 100.

To this end, the processor 180 can request, search, receive, and use data of the learning processor 130 or the memory 170, and can control the components of the AI device 100 to execute a predicted operation or an operation determined to be preferred, among the at least one executable operation.

In this case, if association with an external device is necessary to perform the determined operation, the processor 180 may generate a control signal for controlling the corresponding external device and transmit the generated control signal to the corresponding external device.

The processor 180 can obtain intention information for a user input and transmit user requirements based on the obtained intention information.

The processor 180 can obtain the intention information, corresponding to the user input, using at least one of a speech to text (STT) engine for converting a voice input into a text string or a natural language processing (NLP) engine for obtaining intention information of a natural language.

In this case, at least some of at least one of the STT engine or the NLP engine may be configured as an artificial neural network trained based on a machine learning algorithm. Furthermore, at least one of the STT engine or the NLP engine may have been trained by the learning processor 130, may have been trained by the learning processor 240 of the AI server 200 or may have been trained by distributed processing thereof.

The processor 180 may collect history information including the operation contents of the AI device 100 or the feedback of a user for an operation, may store the history information in the memory 170 or the learning processor 130, or may transmit the history information to an external device, such as the AI server 200. The collected history information may be used to update a learning model.

The processor 18 may control at least some of the components of the AI device 100 in order to execute an application program stored in the memory 170. Moreover, the processor 180 may combine and operate two or more of the components included in the AI device 100 in order to execute the application program.

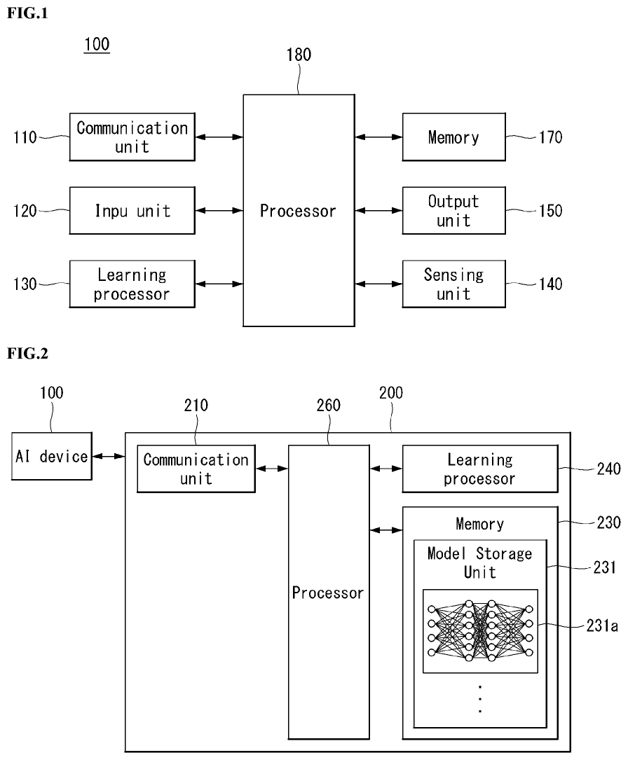

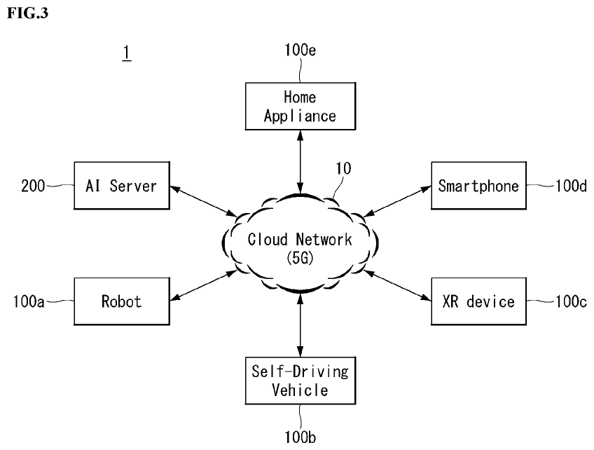

FIG. 2 illustrates an AI server 200 according to an embodiment of the present disclosure.

Referring to FIG. 2, the AI server 200 may mean a device which is trained by an artificial neural network using a machine learning algorithm or which uses a trained artificial neural network. Herein, the AI server 200 consists of a plurality of servers and may perform distributed processing and may be defined as a 5G network. Further, the AI server 200 may be included as a partial configuration of the AI device 100 and may perform at least some of AI processing.

The AI server 200 may include a communication unit 210, a memory 230, a learning processor 240 and a processor 260.

The communication unit 210 may transmit and receive data to and from an external device, such as the AI device 100.

The memory 230 may include a model storage unit 231. The model storage unit 231 may store a model (or artificial neural network 231a) which is being trained or has been trained through the learning processor 240.

The learning processor 240 may train the artificial neural network 231a using learning data. The learning model may be used in the state in which it has been mounted on the AI server 200 of the artificial neural network or may be mounted on an external device, such as the AI device 100, and used.

The learning model may be implemented as hardware, software or a combination of hardware and software. If a part or all of the learning model is implemented as software, one or more instructions configuring the learning model may be stored in the memory 230.

The processor 260 may deduce a result value of new input data using the learning model, and may generate a response or control command based on the deduced result value.

FIG. 3 illustrates an AI system 1 according to an embodiment of the present disclosure.

Referring to FIG. 3, the AI system 1 is connected to at least one of the AI server 200, a robot 100a, a self-driving vehicle 100b, an XR device 100c, a smartphone 100dor home appliances 100e over a cloud network 10. In this case, the robot 100a, the self-driving vehicle 100b, the XR device 100c, the smartphone 100dor the home appliances 100e to which the AI technology is applied may be called AI devices 100a to 100e.

The cloud network 10 may constitute part of cloud computing infra or may mean a network present within cloud computing infra. Here, the cloud network 10 may be configured using the 3G network, the 4G or long term evolution (LTE) network or the 5G network.

That is, the devices 100a to 100e and 200 constituting the AI system 1 may be interconnected over the cloud network 10. Particularly, the devices 100a to 100e and 200 may communicate with each other through a base station, but may directly communicate with each other without the intervention of a base station.

The AI server 200 may include a server for performing AI processing and a server for performing calculation on big data.

The AI server 200 is connected to at least one of the robot 100a, the self-driving vehicle 100b, the XR device 100c, the smartphone 100dor the home appliances 100e, that are AI devices constituting the AI system 1, over the cloud network 10, and may help at least some of the AI processing of the connected AI devices 100a to 100e.

The AI server 200 can train an artificial neural network based on a machine learning algorithm in place of the AI devices 100a to 100e, and can directly store a learning model or transmit the learning model to the AI devices 100a to 100e.

The AI server 200 can receive input data from the AI devices 100a to 100e, deduce a result value of the received input data using the learning model, generate a response or control command based on the deduced result value, and transmit the response or control command to the AI devices 100a to 100e.

Alternatively, the AI devices 100a to 100e can directly deduce a result value of input data using a learning model, and can generate a response or control command based on the deduced result value.

Various implementations of the AI devices 100a to 100e to which the above-described technologies are applied are described below. Herein, the AI devices 100a to 100e illustrated in FIG. 3 may be considered to be detailed implementations of the AI device 100 illustrated in FIG. 1.

AI and Robot to which the Present Disclosure is Applicable

An AI technology is applied to the robot 100a, and the robot 100a may be implemented as a guidance robot, a transport robot, a cleaning robot, a wearable robot, an entertainment robot, a pet robot, an unmanned aerial robot, etc.

The robot 100a may include a robot control module for controlling an operation. The robot control module may mean a software module or a chip in which a software module is implemented using hardware.

The robot 100a may obtain state information of the robot 100a, detect (recognize) a surrounding environment and an object, generate map data, determine a moving path and a running plan, determine a response to a user interaction, or determine an operation, using sensor information obtained from various types of sensors.

The robot 100a may use sensor information obtained by at least one sensor among LIDAR, a radar, and a camera in order to determine the moving path and the running plan.

The robot 100a may perform the above operations using a learning model consisting of at least one artificial neural network. For example, the robot 100a may recognize a surrounding environment and an object using the learning model, and determine an operation using the recognized surrounding environment information or object information. Here, the learning model may have been directly trained in the robot 100a or may have been trained in an external device, such as the AI server 200.

The robot 100a may directly generate results using the learning model and perform an operation, but may perform an operation by transmitting sensor information to an external device, such as the AI server 200, and receiving results generated in response thereto.

The robot 100a may determine a moving path and running plan using at least one of map data, object information detected from sensor information, or object information obtained from an external device. The robot 100a may run along the determined moving path and running plan by controlling the driving unit.

The map data may include object identification information for various objects disposed in the space in which the robot 100a moves. For example, the map data may include object identification information for fixed objects, such as a wall and a door, and movable objects, such as a flowerport and a desk. Furthermore, the object identification information may include a name, a type, a distance, a location, etc.

Furthermore, the robot 100a may perform an operation or run by controlling the driving unit based on a user's control/interaction. In this case, the robot 100a may obtain intention information of an interaction according to a user's behavior or voice speaking, may determine a response based on the obtained intention information, and may perform an operation.

AI and Self-Driving to which the Present Disclosure is Applicable

An AI technology is applied to the self-driving vehicle 100b, and the self-driving vehicle 100b may be implemented as a mobile robot, a vehicle, an unmanned aerial vehicle, etc.

The self-driving vehicle 100b may include a self-driving control module for controlling a self-driving function. The self-driving control module may mean a software module or a chip in which a software module has been implemented using hardware. The self-driving control module may be included in the self-driving vehicle 100b as the component of the self-driving vehicle 100b, but may be configured as separate hardware outside the self-driving vehicle 100b and connected to the self-driving vehicle 100b.

The self-driving vehicle 100b may obtain state information of the self-driving vehicle 100b, detect (recognize) a surrounding environment and object, generate map data, determine a moving path and a running plan, or determine an operation, using sensor information obtained from various types of sensors.

In order to determine the moving path and the running plan, the self-driving vehicle 100b may use sensor information obtained from at least one sensor among LIDAR, a radar and a camera, in the same manner as the robot 100a.

Particularly, the self-driving vehicle 100b may recognize an environment or an object in an area in which a sight is blocked or an area of a predetermined distance or more by receiving sensor information about the environment or the object from external devices, or may receive information about the environment or object that is directly recognized from the external devices.

The self-driving vehicle 100b may perform the above operations using a learning model consisting of at least one artificial neural network. For example, the self-driving vehicle 100b may recognize a surrounding environment and object using a learning model and determine the flow of running using recognized surrounding environment information or object information. In this case, the learning model may have been directly trained in the self-driving vehicle 100b or may have been trained in an external device, such as the AI server 200.

In this case, the self-driving vehicle 100b may directly generate results using the learning model to perform an operation, but may perform an operation by transmitting sensor information to an external device, such as the AI server 200, and receiving results generated in response thereto.

The self-driving vehicle 100b may determine a moving path and running plan using at least one of map data, object information detected from sensor information or object information obtained from an external device. The self-driving vehicle 100b may run based on the determined moving path and running plan by controlling the driver.

The map data may include object identification information for various objects disposed in the space (e.g., road) on which the self-driving vehicle 100b runs. For example, the map data may include object identification information for fixed objects, such as a streetlight, a rock, and a building, etc., and mobile objects, such as a vehicle and a pedestrian.

Furthermore, the object identification information may include a name, a type, a distance, a location, etc.

Furthermore, the self-driving vehicle 100b may perform an operation or run by controlling the driving unit based on a user's control/interaction. In this case, the self-driving vehicle 100b may obtain intention information of an interaction according to a user’ behavior or voice speaking, may determine a response based on the obtained intention information, and may perform an operation.

AI and XR to which the Present Disclosure is Applicable

An AI technology is applied to the XR device 100c, and the XR device 100c may be implemented as a head-mount display (HMD), a head-up display (HUD) provided in a vehicle, television, a mobile phone, a smartphone, a computer, a wearable device, home appliances, a digital signage, a vehicle, a fixed robot or a mobile robot.

The XR device 100c may generate location data and attributes data for three-dimensional points by analyzing three-dimensional point cloud data or image data obtained through various sensors or from an external device, may obtain information on a surrounding space or real object based on the generated location data and attributes data, and may output an XR object by rendering the XR object. For example, the XR device 100c may output an XR object, including additional information for a recognized object, by making the XR object correspond to the corresponding recognized object.

The XR device 100c may perform the above operations using a learning model configured with at least one artificial neural network. For example, the XR device 100c may recognize a real object in three-dimensional point cloud data or image data using a learning model, and may provide information corresponding to the recognized real object. In this case, the learning model may have been directly trained in the XR device 100c or may have been trained in an external device, such as the AI server 200.

In this case, the XR device 100c may directly generate results using a learning model and perform an operation, but may perform an operation by transmitting sensor information to an external device, such as the AI server 200, and receiving results generated in response thereto.

AI, Robot and Self-Driving to which the Present Disclosure is Applicable

An AI technology and a self-driving technology are applied to the robot 100a, and the robot 100a may be implemented as a guidance robot, a transport robot, a cleaning robot, a wearable robot, an entertainment robot, a pet robot, an unmanned aerial robot, etc.

The robot 100a to which the AI technology and the self-driving technology have been applied may mean a robot itself having a self-driving function or may mean the robot 100a interacting with the self-driving vehicle 100b.

The robot 100a having the self-driving function may collectively refer to devices that autonomously move along a given flow without control of a user or autonomously determine a flow and move.

The robot 100a and the self-driving vehicle 100b having the self-driving function may use a common sensing technique in order to determine one or more of a moving path or a running plan. For example, the robot 100a and the self-driving vehicle 100b having the self-driving function may determine one or more of a moving path or a running plan using information sensed through LIDAR, a radar, a camera, etc.

The robot 100a interacting with the self-driving vehicle 100b is present separately from the self-driving vehicle 100b, and may perform an operation associated with a self-driving function inside or outside the self-driving vehicle 100b or associated with a user got in the self-driving vehicle 100b.

In this case, the robot 100a interacting with the self-driving vehicle 100b may control or assist the self-driving function of the self-driving vehicle 100b by obtaining sensor information in place of the self-driving vehicle 100b and providing the sensor information to the self-driving vehicle 100b, or by obtaining sensor information, generating surrounding environment information or object information, and providing the surrounding environment information or object information to the self-driving vehicle 100b.

Alternatively, the robot 100a interacting with the self-driving vehicle 100b may control the function of the self-driving vehicle 100b by monitoring a user got in the self-driving vehicle 100b or through an interaction with a user. For example, if a driver is determined to be a drowsiness state, the robot 100a may activate the self-driving function of the self-driving vehicle 100b or assist control of the driving unit of the self-driving vehicle 100b. In this case, the function of the self-driving vehicle 100b controlled by the robot 100a may include a function provided by a navigation system or audio system provided within the self-driving vehicle 100bn addition to a self-driving function simply.

Alternatively, the robot 100a interacting with the self-driving vehicle 100b may provide information to the self-driving vehicle 100b or may assist a function outside the self-driving vehicle 100bFor example, the robot 100a may provide the self-driving vehicle 100b with traffic information, including signal information, as in a smart traffic light, and may automatically connect an electric charger to a filling inlet through an interaction with the self-driving vehicle 100b as in the automatic electric charger of an electric vehicle.

AI Robot and XR to which the Present Disclosure is Applicable

An AI technology and an XR technology are applied to the robot 100a, and the robot 100a may be implemented as a guidance robot, a transport robot, a cleaning robot, a wearable robot, an entertainment robot, a pet robot, an unmanned aerial robot, a drone, etc.

The robot 100a to which the XR technology has been applied may mean a robot, that is, a target of control/interaction within an XR image. In this case, the robot 100a is different from the XR device 100c, and they may operate in conjunction with each other.

When the robot 100a, that is, a target of control/interaction within an XR image, obtains sensor information from sensors including a camera, the robot 100a or the XR device 100c may generate an XR image based on the sensor information, and the XR device 100c may output the generated XR image. Furthermore, the robot 100a may operate based on a control signal received through the XR device 100c or a user's interaction.

For example, a user may identify a corresponding XR image at timing of the robot 100a, remotely operating in conjunction through an external device, such as the XR device 100c, may adjust the self-driving path of the robot 100a through an interaction, may control an operation or driving, or may identify information of a surrounding object.

AI, Self-Driving and XR to which the Present Disclosure is Applicable

An AI technology and an XR technology are applied to the self-driving vehicle 100b, and the self-driving vehicle 100b may be implemented as a mobile robot, a vehicle, an unmanned aerial vehicle, etc.

The self-driving vehicle 100b to which the XR technology has been applied may mean a self-driving vehicle equipped with means for providing an XR image or a self-driving vehicle, that is, a target of control/interaction within an XR image. Particularly, the self-driving vehicle 100b, that is, a target of control/interaction within an XR image, is different from the XR device 100c, and they may operate in conjunction with each other.

The self-driving vehicle 100b equipped with the means for providing an XR image may obtain sensor information from sensors including a camera, and may output an XR image generated based on the obtained sensor information. For example, the self-driving vehicle 100b includes an HUD, and may provide a passenger with an XR object corresponding to a real object or an object within a screen by outputting an XR image.

In this case, when the XR object is output to the HUD, at least some of the XR object may be output with it overlapping a real object toward which a passenger's view is directed. In contrast, when the XR object is displayed on a display included within the self-driving vehicle 100b, at least some of the XR object may be output so that it overlaps an object within a screen. For example, the self-driving vehicle 100b may output XR objects corresponding to objects, such as a carriageway, another vehicle, a traffic light, a signpost, a two-wheeled vehicle, a pedestrian, and a building.

If the self-driving vehicle 100b that is a target of control/interaction within an XR image obtains sensor information from sensors including a camera, the self-driving vehicle 100b or the XR device 100c may create an XR image based on the sensor information, and the XR device 100c may output the created XR image. Furthermore, the self-driving vehicle 100b may operate based on a control signal received through an external device, such as the XR device 100c, or a user's interaction.

5G System Architecture to which the Present Disclosure is Applicable

A 5G system is an advanced technology from 4G LTE mobile communication technology and supports a new radio access technology (RAT), extended long term evolution (eLTE) as an extended technology of LTE, non-3GPP access (e.g., wireless local area network (WLAN) access), etc. through the evolution of the existing mobile communication network structure or a clean-state structure.

The 5G system is defined based on a service, and an interaction between network functions (NFs) in an architecture for the 5G system can be represented in two ways as follows.

Reference point representation: indicates an interaction between NF services in NFs described by a point-to-point reference point (e.g., N11) between two NFs (e.g., AMF and SMF).

Service-based representation: network functions (e.g., AMF) within a control plane (CP) allow other authenticated network functions to access its services. The representation also includes a point-to-point reference point, if necessary.

Overview of 3GPP System

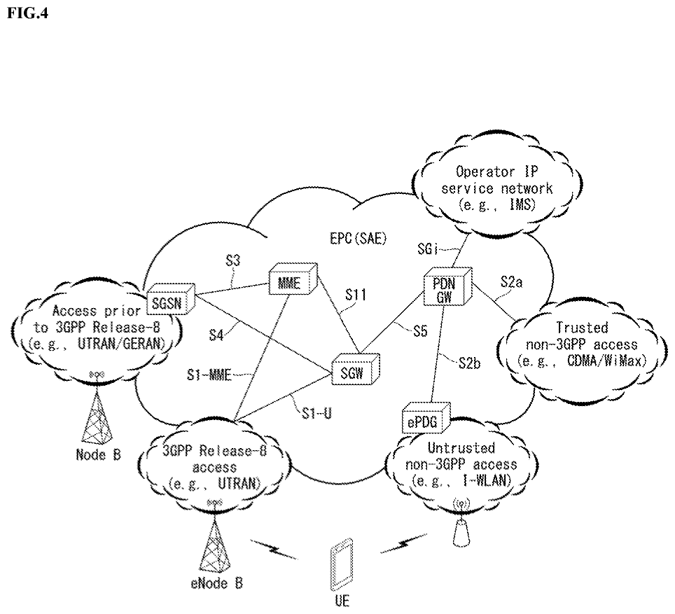

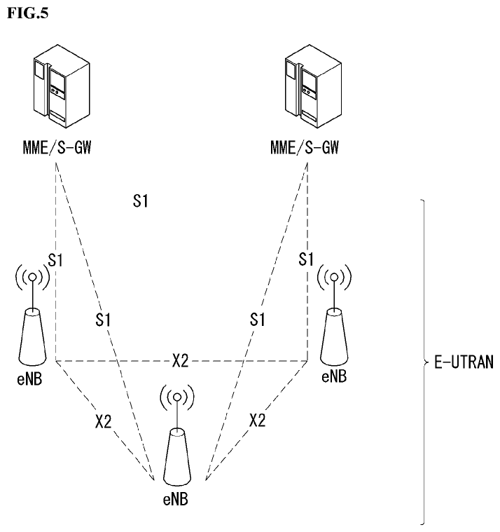

FIG. 4 illustrates various reference points.

In an example of a network structure illustrated in FIG. 4, the SGW and the PDN GW are configured as separate gateways, but the two gateways may be implemented according to a single gateway configuration option.

The MME is an element to perform signaling and control functions for supporting access to the network connection of the UE, allocation, tracking, paging, roaming, and handover of network resources, and so on. The MME controls control plane functions related to subscribers and session management. The MME manages a large number of eNBs and performs signaling of the conventional gateway selection for handover to other 2G/3G networks. Further, the MME performs functions such as security procedures, terminal-to-network session handling, idle terminal location management, and so on.

The SGSN handles all packet data such as mobility management and authentication of the user for another 3GPP network (e.g., GPRS network).

The ePDG serves as a security node for an untrusted non-3GPP network (e.g., I-WLAN, Wi-Fi hotspot, etc.)

As described with reference to FIG. 4, the UE with IP capability can access the IP service network (e.g., IMS) provided by a service provider (i.e., operator) via various components within the EPC based on the non-3GPP access as well as the 3GPP access.

For example, reference points such as S1-U and S1-MME can connect two functions present in different functional entities. The 3GPP system defines a conceptual link connecting two functions present in different functional entities of E-UTRAN and EPC, as a reference point. The following Table 1 summarizes reference points illustrated in FIG. 4. In addition to the example of Table 1, various reference points can exist depending on the network structure.

TABLE 1

| Reference | |
|---|---|
| Point | Description |
| S1-MME | Reference point for the control plane protocol between E- |
| | UTRAN and MME |
| S1-U | Reference point between E-UTRAN and Serving GW for the |
| | per bearer user plane tunneling and inter eNodeB path |
| | switching during handover |
| S3 | It enables user and bearer information exchange for inter |
| | 3GPP access network mobility in idle and/or active state. |
| | This reference point can be used intra-PLMN or inter-PLMN |
| | (e.g. in the case of Inter-PLMN HO). |
| S4 | It provides related control and mobility support between GPRS |
| | Core and the 3GPP Anchor function of Serving GW. In |
| | addition, if Direct Tunnel is not established, it provides the |
| | user plane tunneling. |
| S5 | It provides user plane tunneling and tunnel management |
| | between Serving GW and PDN GW. It is used for Serving |
| | GW relocation due to UE mobility and if the Serving GW |
| | needs to connect to a non-collocated PDN GW for the |
| | required PDN connectivity. |
| S11 | Reference point for the control plane protocol between MME |
| | and SGW |
| SGi | It is the reference point between the PDN GW and the packet |
| | data network. Packet data network may be an operator external |
| | public or private packet data network or an intra operator |
| | packet data network, e.g. for provision of IMS services. This |
| | reference point corresponds to Gi for 3GPP accesses. |

Among the reference points illustrated in FIG. 4, S2a and S2b correspond to non-3GPP interfaces. S2a is a reference point to provide a user plane with related control and mobility support between the trusted non-3GPP access and the PDN GW. S2b is a reference point to provide a user plane with related control and mobility support between the ePDG and the PDN GW.

FIG. 5 illustrates an example of a network structure of an evolved universal terrestrial radio access network (E-UTRAN) to which the present disclosure is applicable.

An E-UTRAN system is an evolved version of the existing UTRAN system and may be, for example, 3GPP LTE/LTE-A system. Communication networks are widely deployed to provide various communication services such as voice (e.g., voice over Internet protocol (VoIP)) through IMS and packet data.

Referring to FIG. 5, an E-UMTS network includes an E-UTRAN, an EPC, and one or more UEs. The E-UTRAN consists of eNBs that provide control plane and user plane protocols to the UE, and the eNBs are interconnected with each other by means of the X2 interface.

X2 user plane (X2-U) interface is defined between the eNBs. The X2-U interface provides non-guaranteed delivery of a user plane packet data unit (PDU). X2 control plane (X2-CP) interface is defined between two neighboring eNBs. The X2-CP performs functions of context delivery between the eNBs, control of user plane tunnel between a source eNB and a target eNB, delivery of handover-related messages, uplink load management, and the like.

The eNB is connected to the UE via a radio interface and is connected to an evolved packet core (EPC) by means of the S1 interface.

S1 user plane (S1-U) interface is defined between the eNB and a serving gateway (S-GW). S21 control plane interface (S1-MME) is defined between the eNB and a mobility management entity (MME). The S1 interface performs functions of evolved packet system (EPS) bearer service management, non-access stratum (NAS) signaling transport, network sharing, MME load balancing, and so on. The S1 interface supports many-to-many-relation between the eNB and the MME/S-GW.

The MME can perform various functions such as NAS signaling security, access stratum (AS) security control, inter-core network (CN) node signaling for supporting mobility between 3GPP access networks, idle mode UE reachability (including control and execution of paging retransmission), tracking area identity (TAI) management (for UE in idle and active modes), PDN GW and SGW selection, MME selection for handover with MME change, SGSN selection for handover to 2G or 3G 3GPP access networks, roaming, authentication, bearer management functions including dedicated bearer establishment, support of public warning system (PWS) (including earthquake and tsunami warning system (ETWS) and commercial mobile alert system (CMAS)) message transmission, and the like.

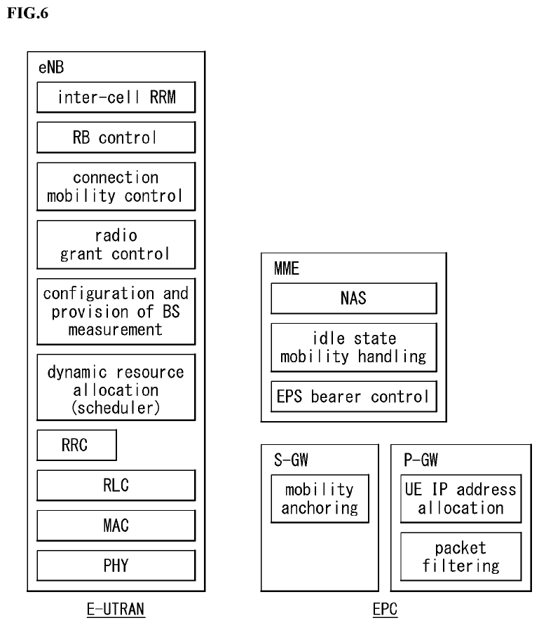

FIG. 6 illustrates an example of a general architecture of E-UTRAN and EPC.

As illustrated in FIG. 6, the eNB can perform functions such as routing to gateway while radio resource control (RRC) connection is activated, scheduling and transmission of paging messages, scheduling and transmission of a broadcast channel (BCH), dynamic allocation of resources in uplink and downlink to the UE, configuration and provision for the measurement of the eNB, radio bearer control, radio admission control, and connection mobility control. The eNB can perform functions such as paging generation in the EPC, management of an LTE IDLE state, ciphering of a user plane, SAE bearer control, and ciphering and integrity protection of NAS signaling.

Annex J of 3GPP TR 23.799 shows various architectures by combining 5G and 4G.

An architecture using NR and NGC is disclosed in 3GPP TS 23.501.

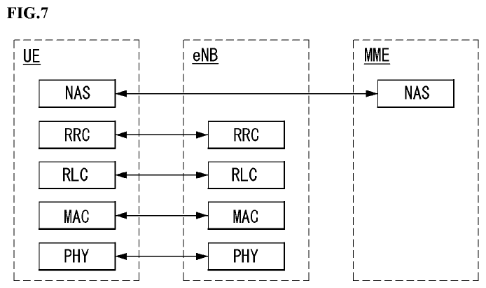

FIG. 7 illustrates an example of a structure of a radio interface protocol in a control plane between a UE and eNB. FIG. 8 illustrates an example of a structure of a radio interface protocol in a user plane between a UE and eNB.

The radio interface protocol is based on 3GPP radio access network standard. The radio interface protocol horizontally consists of a physical layer, a data link layer, and a network layer, and is vertically divided into a user plane for data information transmission and a control plane for control signaling delivery.

The protocol layers may be divided into L1 (first layer), L2 (second layer), and L3 (third layer) based upon three lower layers of an open system interconnection (OSI) standard model that is well known in the art of communication systems.

The layers of the radio protocol in the control plane illustrated in FIG. 7 and the layers of the radio protocol in the user plane illustrated in FIG. 8 are described below.

The physical layer, the first layer, provides an information transfer service using a physical channel. The physical layer is connected with a medium access control (MAC) layer located at a higher level via a transport channel, and data between the MAC layer and the physical layer is transferred via the transport channel. Data is transferred between different physical layers, i.e., between physical layers of a transmission side and a reception side via the physical channel.

The physical channel consists of several subframes on a time axis and several subcarriers on a frequency axis. Here, one subframe consists of a plurality of OFDM symbols and a plurality of subcarriers on the time axis. One subframe consists of a plurality of resource blocks, and one resource block consists of a plurality of OFDM symbols and a plurality of subcarriers. A unit time, a transmission time interval (TTI), at which data is transmitted is 1 ms corresponding to one subframe.

Physical channels existing in the physical layers of the transmission side and the reception side may be divided into a physical downlink shared channel (PDSCH) and a physical uplink shared channel (PUSCH) that are data channels, and a physical downlink control channel (PDCCH), a physical control format indicator channel (PCFICH), a physical hybrid-ARQ indicator channel (PHICH), and a physical uplink control channel (PUCCH) that are control channels, according to 3GPP LTE.

There are several layers in the second layer. A medium access control (MAC) layer of the second layer functions to map various logical channels to various transfer channels, and also performs a function of logical channel multiplexing for mapping several logical channels to one transfer channel. The MAC layer is connected to a radio link control (RLC) layer, that is an upper layer, via the logical channel. The logical channel is roughly divided into a control channel used to transmit information of the control plane and a traffic channel used to transmit information of the user plane according to a type of transmitted information.

The MAC layer of the second layer segments and concatenate data received from the upper layer and adjusts a data size so that a lower layer is adapted to transmit data to a radio section.

A packet data convergence protocol (PDCP) layer of the second layer performs a header compression function of reducing an IP packet header size that has a relatively large size and contains unnecessary control information, in order to efficiently transmit data in a radio section having a small bandwidth upon transmission of IP packet such as IPv4 or IPv6. In addition, in the LTE system, the PDCP layer also performs a security function, which consists of ciphering for preventing data interception by a third party and integrity protection for preventing data manipulation by a third party.

A radio resource control (RRC) layer located at the uppermost part of the third layer is defined only in the control plane and is responsible for controlling logical channels, transport channels, and physical channels in relation to configuration, re-configuration, and release of radio bearers (RBs). The RB means services provided by the second layer to ensure data transfer between the UE and the E-UTRAN.

If an RRC connection is established between an RRC layer of the UE and an RRC layer of a wireless network, the UE is in an RRC connected mode. Otherwise, the UE is in an RRC idle mode.

An RRC state of the UE and an RRC connection method are described below. The RRC state refers to a state in which the RRC of the UE is or is not logically connected with the RRC of the E-UTRAN. The RRC state of the UE having logical connection with the RRC of the E-UTRAN is referred to as an RRC_CONNECTED state, and the RRC state of the UE not having logical connection with the RRC of the E-UTRAN is referred to as an RRC_IDLE state. Since the UE in the RRC_CONNECTED state has the RRC connection, the E-UTRAN can identify the presence of the corresponding UE on a per cell basis and thus efficiently control the UE. On the other hand, the E-UTRAN cannot identify the presence of the UE of the RRC_IDLE state, and the UE in the RRC_IDLE state is managed by a core network based on a tracking area (TA) which is an area unit larger than the cell. That is, for the UE in the RRC_IDLE state, only presence or absence of the corresponding UE is identified in an area unit larger than the cell. In order for the UE of the RRC_IDLE state to receive typical mobile communication services such as voice and data, the UE should transition to the RRC_CONNECTED state. Each TA is distinguished from another TA by a tracking area identity (TAI) thereof. The UE may configure the TAI through a tracking area code (TAC) which is information broadcasted from a cell.

When the user initially turns on the UE, the UE first searches for a proper cell, and then establishes RRC connection in the corresponding cell and registers information of the UE in the core network. Thereafter, the UE stays in the RRC_IDLE state. The UE staying in the RRC_IDLE state (re)selects a cell and checks system information or paging information, if necessary. This operation is called camping on a cell. Only when the UE staying in the RRC_IDLE state needs to establish the RRC connection, the UE establishes the RRC connection with the RRC layer of the E-UTRAN through a RRC connection procedure and transitions to the RRC_CONNECTED state. There are several cases where the UE remaining in the RRC_IDLE state needs to establish the RRC connection. For example, the cases may include an attempt of a user to make a phone call, an attempt to transmit data, or transmission of a response message when receiving a paging message from the E-UTRAN.

A non-access stratum (NAS) layer positioned over the RRC layer performs functions such as session management and mobility management.

The NAS layer shown in FIG. 7 is described in detail below.

The evolved session management (ESM) belonging to the NAS layer performs functions such as default bearer management and dedicated bearer management to control the UE to use a PS service from a network. The default bearer resources are allocated from a network when they are accessed to the network upon first access to a specific packet data network (PDN). In this instance, the network allocates an IP address available for the UE so that the UE can use a data service, and also allocates QoS of a default bearer. LTE roughly supports two types of bearers including a bearer with guaranteed bit rate (GBR) QoS characteristics for guaranteeing a specific bandwidth for data transmission/reception and a non-GBR bearer with best effort QoS characteristics without guaranteeing a bandwidth. The default bearer is allocated the non-GBR bearer. The dedicated bearer may be allocated a bearer with GBR or non-GBR QoS characteristics.

A bearer that the network allocates to the UE is referred to as an evolved packet service (EPS) bearer. When the network allocates the EPS bearer to the UE, the network assigns one ID. This ID is called an EPS bearer ID. One EPS bearer has QoS characteristics of a maximum bit rate (MBR) and/or a guaranteed bit rate (GBR).

UE's Network Selection Procedure

A UE being camped on a cell is described in detail as follow.

If the UE is switched on or intends to newly access a cell, the UE performs an initial cell search procedure including, for example, obtaining time and frequency synchronizations with the cell and detecting a physical layer cell identity of the cell. To this end, the UE may receive a downlink (DL) synchronization signal from the eNB to adjust the eNB to the DL synchronization, and may obtain information of a cell identity (ID), etc. If the UE is switched on, the PLMN is selected by the NAS. For the selected PLMN, associated RAT(s) may be set. The NAS provides the UE with a list of equivalent PLMNs, that an access stratum (AS) uses for the cell selection or the cell reselection, if available.

With the cell selection, the UE searches for a suitable cell of the selected PLMN and chooses a cell to provide available services. Further, the UE tunes to a control channel of the cell.

The choosing is known as “camping on the cell”.

If the UE finds a more suitable cell according to a cell reselection criteria, the UE reselects the cell and camps on the cell. If the new cell does not belong to at least one tracking area in which the UE is registered, a location registration is performed.

The purpose of camping on a cell in an idle mode may be five:

It enables the UE to receive system information from the PLMN.

When registered and if the UE want to establish an RRC connection, the UE can perform this by initially accessing the network on a control channel of a cell on which the UE is camped.

If the PLMN receives a call for the registered UE, the PLMN can know (in most cases) a set of tracking areas in which the UE is camped. Then, the PLMN can send a “paging” message for the UE on control channels of all the cells in this set of tracking areas. The UE will then receive the paging message because the UE is tuned to the control channel of the cell in one of the registered tracking areas, and the UE can respond on the control channel.

It enables the UE to receive earthquake and tsunami warning system (ETWS) and commercial mobile alert system (CMAS) notifications.

It enables the UE to receive MBMS services.

If the UE is camped on a cell, the UE regularly searches for a better cell according to the cell reselection criteria. If the better cell is found, the found cell is selected by the UE. A change of the cell may imply a change of the RAT.

For normal services, the UE camps on a suitable cell and tunes to a control channel of the cell so that the UE can:

receive system information from the PLMN

receive registration area information, for example, tracking area information from the PLMN

receive other AS and NAS information

if registered, the UE receives paging and notification messages from the PLMN and initiate transfer to a connected mode

In the present disclosure, “barred cell” may refers to a cell on which a UE is not allowed to camp. “Camped on a cell” means that a UE has completed the cell selection/reselection process and has chosen a cell.

If the UE camps on a cell, the UE monitors system information and (in most cases) paging information on the corresponding cell. “Camped on any cell” means that the UE is in an idle mode and has completed the cell selection/reselection process and has chosen a cell irrespective of the PLMN identity. Further, a cell on which the UE camps is called a serving cell.

The description related to the PLMN selection is additionally described in 3GPP TS.22.011 23.122, 36.304.

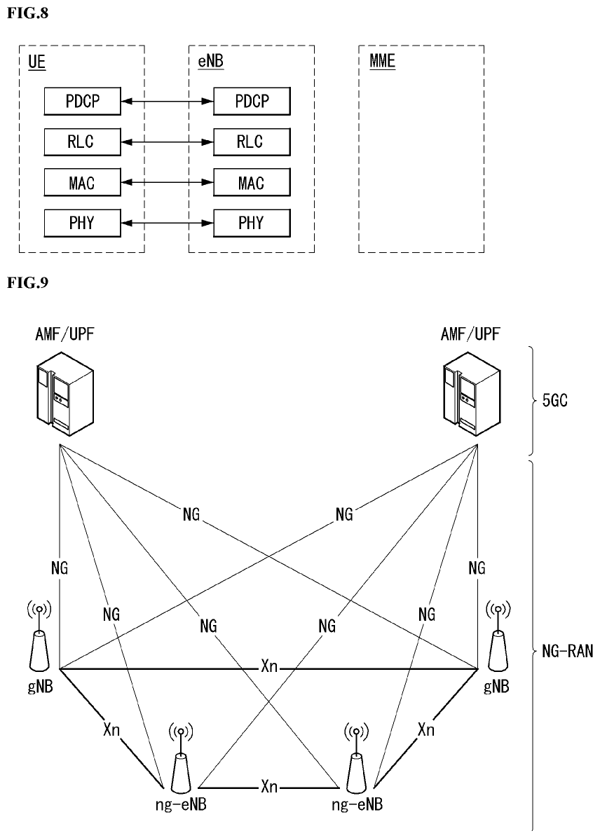

FIG. 9 illustrates an architecture of a general NR-RAN.

Referring to FIG. 9, NG-RAN nodes may be one of the followings.

gNB providing an NR user plane and a control plane protocol towards the UE; or

ng-eNB providing a E-UTRA user plane and the control plane protocol towards the UE; or

The gNB and the ng-eNB are connected to each other via an Xn interface. In addition, the gNB and the ng-eNB are connected to an access and mobility management function (AMF) and to a user plane function (UPF) through an NG-U interface, via an NG interface for 5GC, and more specifically, via an NG-C interface (see 3GPP TS 23.501 [3]).

For reference, an architecture for a functional separation and an F1 interface are defined in 3GPP TS 38.401 [4].

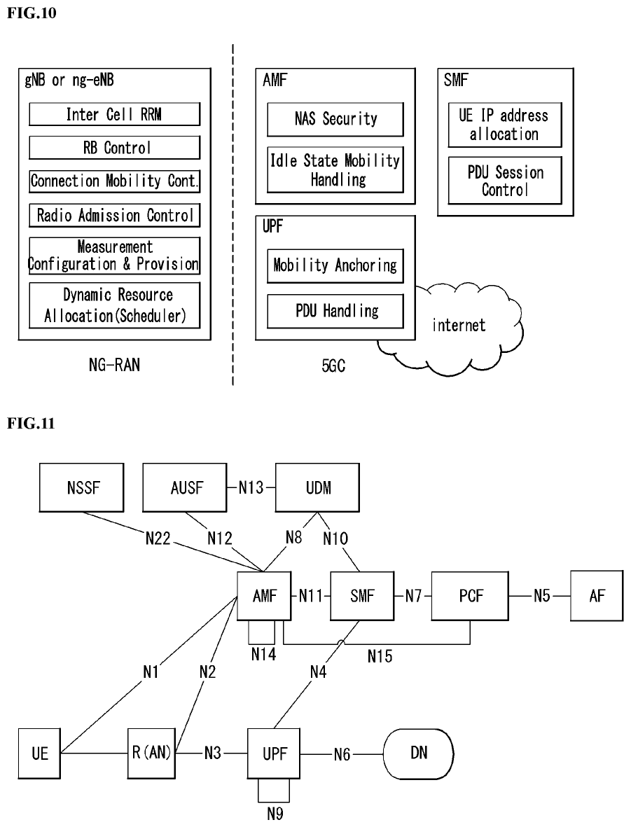

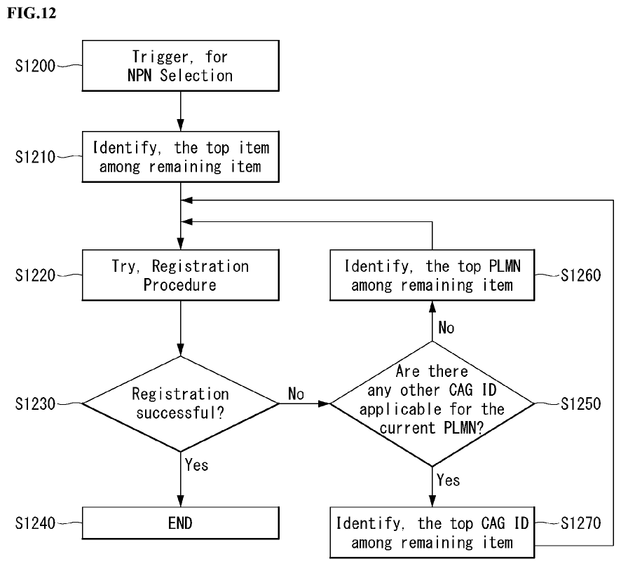

FIG. 10 illustrates a functional separation of a general NG-RAN and 5GC.

Referring to FIG. 10, a yellow box represents logical nodes and a white box represent major functions.

The gNB and the ng-eNB host the following functions.

Radio resource management function: radio bearer control, radio admission control, access mobility control, and dynamic resource allocation for a UE on both uplink and downlink (scheduling)

IP header compression, encryption and data integrity protection;

When the routing for the AMF cannot be determined from the information provided by the UE, selection of the AMF from the IMT-2000 3GPP-UE attachment;

Routing of user plane data to UPF;

Transfer of control plane information to AMF;

Connection establishment and release

Paging message scheduling and transmission

System broadcast information scheduling and transmission (provided by AMF or OAM)

Measurement and measurement reporting configuration for mobility and scheduling

Indication of transport level packet on uplink

Session management;

Network slicing support;

QoS flow management and mapping for data radio bearer

UE support in RRC_INACTIVE state

NAS message distribution function;

Radio access network sharing;

Double connection;

Close linkage between NR and E-UTRA

The AMF hosts the following main functions (see 3GPP TS 23.501 [3]).

NAS signal termination;

NAS signal security;

AS security control;

Transfer of signal between CN nodes for movement between 3GPP access networks;

Idle mode UE connectivity (including paging retransmission control and execution)

Registration area management;

In-system and inter-system mobility support

Access authentication;

Granting access, including roaming permission check;

Mobility management control (subscriptions and policies)

Network slicing support;

SMF selection

The UPF hosts the following main functions (see 3GPP TS 23.501 [3]).

Anchor point for intra-/inter-RAT mobility (if applicable)

External PDU session points interconnected to data network

Packet routing and forwarding;

Packet inspection and user plane part of policy rule enforcement

Traffic usage reporting;

Uplink classifier to support traffic flow to the data network

Branch point for multi-homed PDU session support;

QoS processing for user plane (e.g., packet filtering, gate, UL/DL rate enforcement)

Uplink traffic verification (SDF and QoS flow mapping)

Downlink packet buffering and triggering downlink data notifications

Session management function (SMF) hosts the following key functions (see 3GPP TS 23.501 [3]).

Session management;

UE IP address allocation and management

UP function selection and control;

Configure traffic steering to route traffic to appropriate target in UPF

Policy enforcement and partial control of QoS

Downlink data notification

FIG. 11 illustrates an example of a general architecture of 5G.

The following is a description of each reference interface and node in FIG. 11.

The access and mobility management function (AMF) includes CN inter-node signaling for mobility between 3GPP access networks, termination of a radio access network (RAN) CP interfaces (N2), termination of NAS signaling (N1), registration management (registration area management), idle mode UE reachability, support for network slicing, SMF selection, and the like.

Some or all functions of the AMF may be supported within a single instance of one AMF.

The data network (DN) means, for example, an operator service, an Internet connection, a third party service, or the like. The DN transmits a downlink protocol data unit (PDU) to the UPF or receives, from the UPF, a PDU which is transmitted from the UE.

A policy control function (PCF) provides a function of receiving information on a packet flow from an application server and determining a policy such as mobility management, session management, and the like.

The session management function (SMF) provides a session management function, and when the UE has a plurality of sessions, may be managed by different SMFs for each session.

Some or all functions of the SMF may be supported within a single instance of one SMF.

Unified data management (UDM) stores user subscription data, policy data, and the like.

The user plane function (UPF) transmits a downlink PDU received from the DN to the UE via (R)AN and transmits, to the DN, the uplink PDU received from the UE via the (R)AN.

An application function (AF) interoperates with a 3GPP core network for providing services (e.g., support functions such as influence of applications on traffic routing, access to network capability exposure, interaction with policy frameworks for policy control).

The (radio) access network is referred to as a new radio access network that supports both evolved E-UTRA (E-UTRA) as an evolved version of 4G radio access technology and new radio access technology (NR new radio) (for example, gNB).

The gNB supports functions such as radio resource management functions (i.e., radio bearer control, radio admission control, connection mobility control, dynamic allocation of resources to UE on uplink/downlink) (i.e., scheduling)), and the like.

The user equipment (UE) means a user device.

In the 3GPP system, a conceptual link connecting between NFs in a 5G system is defined as a reference point.

N1 means a reference point between the UE and the AMF, N2 means the reference point between the (R)AN and the AMF, N3 means a reference point between the (R)AN and the UPF, N4 means a reference point between the SMF and the UPF, N6 is a reference point between the UPF and the data network, N9 means a reference point between two core UPFs, N5 means a reference point between the PCF and the AF, N7 means a reference point between the SMF and the PCF, N24 means a reference point between a PCF in a visited network and a PCF in a home network, N8 means a reference point between the UDM and the AMF, N10 means a reference point between the UDM and the SMF, N1 means a reference point between the AMF and the SMF, N12 means a reference point between the AMF and an authentication server function (AUSF), N13 means a reference point between the UDM and the AUSF, N14 means a reference point between two AMFs, N15 means a reference point between the PCF and the AMF in the case of a non-roaming scenario and a reference point between the PCF in the visited network and the AMF in the case of a roaming scenario, N16 means a reference point between two SMFs (in the roaming scenario, a reference point between the SMF in the visited network and the SMF between the home network), N17 means a reference point between the AMF and a 5G-equipment identity register (5G-EIR), N18 means a reference point between the AMF and an unstructured data storage function (UDSF), N22 means a reference point between the AMF and a network slice selection function (NSSF), N23 means a reference point between the PCF and a network data analytics function (NWDAF), N24 means a reference point between the NSSF and the NWDAF, N27 means a reference point between a network repository function (NRF) in the visited network and the NRF in the home network, N31 means a reference point between the NSSF in the visited network and the NSSF in the home network, N32 means a reference point between a security protection proxy (SEPP) in the visited network and SEPP in the home network, N33 means a reference point between a network exposure function (NEF) and the AF, N40 means a reference point between the SMF and a charging function (CHF), and N50 means a reference point between the AMF and a circuit bearer control function (CBCF).

Meanwhile, FIG. 11 illustrates a reference model for a case where a UE accesses one DN using one PDU session, for the convenience of description, but the reference model is not limited thereto.

In the above description, for the convenience of description, the eNB is described based on the EPS system, but the eNB may be replaced by a gNB, a mobility management (MM) function of the MME may be replaced by the AMF, a SM function of S/P-GW may be replaced by the SMF, and a user plane related function of the S/P-GW may be replaced by the 5G system using the UPF and the like.

In the above description, the present disclosure has been described based on EPS, but the content may be supported by similar operations through a similar purpose process/message/information and the like in the 5G system.

Non Public Network

Non-public networks exemplified in the present specification are as follows.

5.X Support for Non-Public Networks

5.X.1 General

A Non-Public Network (NPN) is a 5GS deployed for non-public use, see TS 22.261 [2]. An NPN may be deployed as

a stand-alone Non-Public Network, i.e. not relying on network functions provided by a public PLMN, or

a non-stand-alone Non-Public Network, i.e. with the support of a public PLMN.

Stand-alone NPN 5GS deployments are based on the architecture depicted in clause 4.2.3 and the additional functionality covered in clause 5.X.2.

Non-stand-alone NPN can be enabled using network slicing (see Annex X). To prevent unauthorized UEs from trying to access a non-stand-alone NPN, the Closed Access Group (CAG) functionality described in clause 5.X.3 can be used in addition.

5.X.2 Stand-Alone Non-Public Networks

5.X.2.1 Identifiers

The combination of a PLMN ID and Network identifier (NID) identifies a stand-alone NPN.

NOTE 1: The PLMN ID used for NPNs is not required to be unique. PLMN IDs reserved for use by private networks can be used for non-public networks.

The NID shall support two assignment models:

Locally managed NIDs are assumed to be chosen individually by NPNs at deployment time (and may therefore not be unique in all scenarios)

Universally managed NIDs are managed by a central entity and are assumed to be globally unique.

NOTE 2: Which legal entity manages the number space is beyond the scope of this specification.

The UE shall be able to distinguish whether a NID is locally or universally applicable.

Editor's Note: The need for such differentiation is FFS.

A optional human-readable network name helps to identify an NPN during manual network selection. The human-readable name may be unique.

5.X.2.2 Broadcast System Information

NG-RAN nodes which provide access to NPNs broadcast the following information:

PLMN ID

NOTE 1: The PLMN ID used for NPNs is not required to be unique. Non-unique PLMN IDs reserved for private networks can be used, e.g. based on mobile country code (MCC) 999 as assigned by ITU [X]).

NID per PLMN ID identifying the non-public networks NG-RAN provides access to

Editor's Note: It is FFS whether it shall be possible to broadcast a list of NIDs per PLMN ID per cell or only a single NID per PLMN ID in a cell.

Optionally a human-readable network name per NID

NOTE 2: The human-readable network name per NID is only used for manual selection.

Optionally information, as described in TS 38.331 [28] and in TS 38.304 [50], to prevent UEs not supporting NPNs from accessing the cell, e.g. in case the cell only provides access to non-public networks.

Editor's Note: It is assumed that existing Rel-15 indication(s) can be used to prevent Rel-15 UEs and UEs of later releases that are not supporting non-public networks from accessing the cell.

5.X.2.3 UE Configuration and Subscription Aspects

An NPN-enabled UE is configured with subscriber identifiers and credentials for one or multiple NPNs identified by the combination of PLMN ID and NID.

A subscriber of a NPN is identified by a SUPI containing a network-specific identifier that takes the form of a Network Access Identifier (NAI) using the NAI RFC 7542 [20] based user identification as defined in TS 23.003 [19] clause 28.2.2. The realm part of the NAI may include the NID of the non-public network.

An NPN-enabled UE supports the NPN mode of operation. When set to operate in NPN mode of operation the UE only selects and registers with NPNs and does not perform normal PLMN selection procedures as defined in clause 4.4 of TS 23.122 [17].

If a UE is not set to operate in NPN mode of operation, even if it is NPN-enabled, the UE does not select and register with NPNs. A UE not set to operate in NPN mode of operation performs PLMN selection procedures as defined in in clause 4.4 of TS 23.122 [17].

NOTE: Details of activation and deactivation of NPN mode of operation are up to UE implementation.

5.X.2.4 Network Selection in NPN Mode of Operation

UEs operating in NPN mode of operation read the available PLMN IDs and available NIDs from the broadcast system information and take it into account during network selection.

For automatic network selection, the UE selects and attempts to register with the available NPN identified by a PLMN ID and NID for which the UE has SUPI and credentials. If multiple NPNs are available that the UE has SUPI and credentials for, then the priority order for selecting and attempting to register with NPNs is based on UE implementation.

For manual network selection UEs operating in NPN mode present the list of NIDs and related human-readable names (if available) of the available NPNs the UE has SUPI and credentials for.

NOTE: The NPN selection is defined in TS 23.122 [17].

When a UE performs Initial Registration to an NPN, the UE shall indicate the selected NID and the corresponding PLMN ID to NG-RAN. NG-RAN shall inform the AMF of the selected PLMN ID and NID.

5.X.2.5 Cell (Re-)Selection in NPN Mode of Operation

UEs operating in NPN mode of operation only select cells and networks broadcasting both PLMN ID and NID.

NOTE: Details on the NR idle mode procedures for NPN cell selection is defined in TS 38.331 [28] and in TS 38.304 [50].

5.X.2.6 Access to PLMN Services Via Non-Public Networks

A UE in NPN mode of operation may access PLMN services following the same architectural principles as specified in clause 4.2.8 and the stand-alone NPN taking the role of “Untrusted non-3GPP access”.

5.X.2.7 Access to Non-Public Network Services Via PLMN

A UE may access NPN services following the same architectural principles as specified in clause 4.2.8 and the PLMN taking the role of “Untrusted non-3GPP access”.

PLMN Selection

PLMN selections exemplified in the present specification are as follows.

3.2.1 General

The UE shall support both manual and automatic network selection mechanisms (modes). The UE shall select the last mode used, as the default mode, at every switch-on.

As an optional feature of the ME, the user shall be able to set a preference in the ME for the mode that shall be used at switch on. If set then the ME shall select this preference rather than the default mode.

Note: By defaulting to the last mode used, e.g. manual network selection, the undesired automatic selection of an adjacent PLMN instead of the desired HPLMN in border areas, can be avoided at switch-on.

The user shall be given the opportunity to change mode at any time.

Except as defined below, the MMI shall be at the discretion of the UE manufacturer.

The UE shall contain display functions by which Available PLMNs and the Selected PLMN can be indicated.

In order not to confuse the user, the same definitions of PLMN names shall be applied consistently both in registered mode and in the list presented to the user when in manual mode.

In shared networks a radio access network can be part of more than one PLMN. This shall be transparent to the user, i.e. the UE shall be able to indicate those PLMNs to the user, and the UE shall support network selection among those PLMNs, as in non-shared networks.

3.2.2 Procedures

3.2.2.1 General

In the following procedures the UE selects and attempts registration on PLMNs.

In this TS, the term “PLMN Selection” defines a UE based procedure, whereby candidate PLMNs are chosen, one at a time, for attempted registration.

A User Controlled PLMN Selector data field exists on the USIM to allow the user to indicate a preference for network selection. It shall be possible for the user to update the User Controlled PLMN Selector data field, but it shall not be possible to update this data field over the radio interface, e.g. using SIM Application Toolkit.

It shall be possible to have an Operator Controlled PLMN Selector list and a User Controlled PLMN Selector list stored on the SIM/USIM card. Both PLMN Selector lists may contain a list of preferred PLMNs in priority order. It shall be possible to have an associated Access Technology identifier e.g., N G-RAN, E-UTRAN (WB-S1 mode), E-UTRAN(NB-S1 mode), UTRAN, GERAN or GERAN EC-GSM-IoT associated with each entry in the PLMN Selector lists.

The UE shall utilise all the information stored in the USIM related to network selection, e.g. HPLMN, Operator controlled PLMN Selector list, User Controlled PLMN Selector list, Forbidden PLMN list.

Note 1: A PLMN in a Selector list, including HPLMN, may have multiple occurrences, with different access technology identifiers and/or identifier for non public network.

The UE shall ignore those PLMN+access technology entries in the User Controlled PLMN selector and Operator Controlled PLMN selector lists where the associated Access Technology is not supported by the UE. In the case that there are multiple associated Access Technology identifiers in an entry the UE shall not ignore the entry if it includes any associated Access Technology that is supported by the UE.

It shall be possible to handle cases where one network operator accepts access from access networks with different network IDs. It shall also be possible to indicate to the UE that a group of PLMNs are equivalent to the registered PLMN regarding PLMN selection, cell selection/re-selection and handover.

It shall be possible for the home network operator to identify alternative Network IDs as the HPLMN. It shall be possible for the home network operator to store in the USIM an indication to the UE that a group of PLMNs are treated as the HPLMN regarding PLMN selection. Any PLMN to be declared as an equivalent to the HPLMN shall be present within the EHPLMN list and is called an EHPLMN. The EHPLMN list replaces the HPLMN derived from the IMSI. When the EHPLMN list is present, any PLMN in this list shall be treated as the HPLMN in all the network and cell selection procedures.

If registration on a PLMN is successful, the UE shall indicate this PLMN (the “registered PLMN”) and be capable of making and receiving calls on it. The identity of the registered PLMN shall be stored on the SIM/USIM. However, if registration is unsuccessful, the UE shall ensure that there is no registered PLMN stored in the SIM/USIM.

If a registration is unsuccessful because the IMSI is unknown in the home network, or the UE is illegal, then the UE shall not allow any further registration attempts on any network, until the UE is next powered-up or a SIM/USIM is inserted.

If the registration is unsuccessful due to the lack to service entitlement, specific behaviour by the UE may be required, see clause 3.2.2.4.

To avoid unnecessary registration attempts, lists of forbidden PLMNs, TAs and LAs are maintained in the UE, see clause 3.2.2.4 and 3GPP TS 23.122 [3].

Registration attempts shall not be made by UEs without a SIM/USIM inserted.

An UE/ME which has not successfully registered shall nevertheless be able to make emergency call attempts on an available PLMN (which supports the emergency call teleservice), without the need for the user to select a PLMN. An available PLMN is determined by radio characteristics (3GPP TS 23.122 [3]).

3.2.2.2 At switch-on or recovery from lack of coverage

At switch on, when in coverage of the last registered PLMN as stored in the SIM/USIM, the UE will attach to that network.

As an option, in automatic selection mode, when no EHPLMN list is present, the UE may select the HPLMN. When the EHPLMN list is present, the UE may select the highest priority EHPLMN among the available EHPLMNs. The operator shall be able to control the UE behaviour by USIM configuration.

As an option, if the UE is in manual network selection mode at switch-on

if the last registered PLMN is unavailable and no equivalent PLMN is available,

and the UE finds it is in coverage of either the HPLMN or an EHPLMN

then the UE should register on the corresponding HPLMN or EHPLMN. The UE remains in manual mode.

If the UE returns to coverage of the PLMN on which it is already registered (as indicated by the registered PLMN stored in the SIM/USIM), the UE shall perform a location update to a new location area if necessary. As an alternative option to this, if the UE is in automatic network selection mode and it finds coverage of the HPLMN or any EHPLMN, the UE may register on the HPLMN (if the EHPLMN list is not present) or the highest priority EHPLMN of the available EHPLMNs (if the EHPLMN list is present) and not return to the last registered PLMN. If the EHPLMN list is present and not empty, it shall be used. The operator shall be able to control by USIM configuration whether an UE that supports this option shall follow this alternative behaviour.

NOTE: At switch-on and at recovery from lack of coverage, a UE in automatic network selection mode can attempt registration once the RPLMN or, if the above option is applicable, the HPLMN or EHPLMN is found on an access technology.

The default behaviour for a UE is to select the last registered PLMN.

If there is no registered PLMN stored in the SIM/USIM, or if this PLMN is unavailable and no equivalent PLMN is available, or the attempted registration fails, the UE shall follow one of the following procedures for network selection:

A) Automatic Network Selection Mode

The UE shall select and attempt registration on other PLMNs, if available and allowable, if the location area is not in the list of “forbidden LAs for roaming” and the tracking area is not in the list of “forbidden TAs for roaming” (see 3GPP TS 23.122 [3]), in the following order:

i) An EHPLMN if the EHPLMN list is present or the HPLMN (derived from the IMSI) if the EHPLMN list is not present for preferred access technologies in the order specified. In the case that there are multiple EHPLMNs present then the highest priority EHPLMN shall be selected. It shall be possible to configure a voice capable UE so that it shall not attempt registration on a PLMN if all cells identified as belonging to the PLMN do not support the corresponding voice service;

ii) each entry in the “User Controlled PLMN Selector with Access Technology” data field in the SIM/USIM (in priority order). It shall be possible to configure a voice capable UE so that it shall not attempt registration on a PLMN if all cells identified as belonging to the PLMN do not support the corresponding voice service;

iii) each entry in the “Operator Controlled PLMN Selector with Access Technology” data field in the SIM/USIM (in priority order). It shall be possible to configure a voice capable UE so that it shall not attempt registration on a PLMN if all cells identified as belonging to the PLMN do not support the corresponding voice service;

iv) other PLMN/access technology combinations with sufficient received signal quality (see 3GPP TS 23.122 [3]) in random order. It shall be possible to configure a voice capable UE so that it shall not attempt registration on a PLMN if all cells identified as belonging to the PLMN do not support the corresponding voice service;

v) all other PLMN/access technology combinations in order of decreasing signal quality. It shall be possible to configure a voice capable UE so that it shall not attempt registration on a PLMN if all cells identified as belonging to the PLMN do not support the corresponding voice service.

In the case of a UE operating in UE operation mode A or B, an allowable PLMN is one which is not in the “Forbidden PLMN” data field in the SIM/USIM. This data field may be extended in the ME memory (see clause 3.2.2.4). In the case of a UE operating in UE operation mode C, an allowable PLMN is one which is not in the “Forbidden PLMN” data field in the SIM/USIM or in the list of “forbidden PLMNs for GPRS service” in the ME.

If successful registration is achieved, the UE shall indicate the selected PLMN.

If registration cannot be achieved on any PLMN and at least one PLMN offering restricted local operator services has been found, the UE shall obtain user consent for restricted local operator services and the UE may use a list of preferred PLMNs for restricted local operator services stored in the ME. If none of the preferred PLMNs for restricted local operator services is available, the UE shall select any available PLMN offering restricted local operator services. If one of these PLMNs for restricted local operator service is chosen, the UE shall indicate the choice. If none are selected, the UE shall wait until a new PLMN is detected, or new location areas or tracking areas of an allowed PLMN are found which are not in the forbidden LA or TA list(s), and then repeat the procedure.

If registration cannot be achieved on any PLMN and no PLMN offering restricted local operator services has been found, the UE shall indicate “no service” to the user, wait until a new PLMN is detected, or new location areas or tracking areas of an allowed PLMN are found which are not in the forbidden LA or TA list(s), and then repeat the procedure.

When registration cannot be achieved, different (discontinuous) PLMN search schemes may be used in order to minimize the access time while maintaining battery life, e.g. by prioritising the search in favour of BCCH carriers which have a high probability of belonging to an available and allowable PLMN.

B) Manual Network Selection Mode

The UE shall indicate PLMNs, including “Forbidden PLMNs”, which are available. If there are none, this shall also be indicated. The HPLMN of the user may provide on the USIM additional information about the available PLMNs, if this is provided then the UE shall indicate that information to the user. This information, provided as free text may include:

Preferred partner,

roaming agreement status,

supported services

Furthermore, the UE may indicate whether the available PLMNs are present on one of the PLMN selector lists (e.g. EHPLMN, User Controlled, Operator Controlled or Forbidden) as well as not being present on any of the lists.

For the purpose of presenting the names of the available PLMNs to the user, the ME shall use the USIM defined names if available or other PLMN naming rules in priority order as defined in 3GPP TS 22.101 [7] (Country/PLMN indication).

Any available PLMNs shall be presented in the following order:

i) HPLMN (if the EHPLMN list is not present); or if one or more of the EHPLMNs are available then based on an optional data field on the USIM either the highest priority available EHPLMN is to be presented to the user or all available EHPLMNs are presented to the user in priority order; if the data field is not present, then only the highest priority available EHPLMN is presented;

ii) PLMNs contained in the “User Controlled PLMN Selector” data field in the SIM/USIM (in priority order);

iii) PLMNs contained in the “Operator Controlled PLMN Selector” data field in the SIM/USIM (in priority order);

iv) other PLMN/access technology combinations with sufficient received signal level (see 3GPP TS 23.122 [3]) in random order;

v) all other PLMN/access technology combinations in order of decreasing signal strength.

If a PLMN does not support voice services then this shall be indicated to the user.

The user may select the desired PLMN and the UE shall attempt registration on this PLMN. (This may take place at any time during the presentation of PLMNs.)

If registration cannot be achieved on any PLMN and at least one PLMN offering restricted local operator services has been found, the UE shall obtain user consent for restricted local operator services and offer the user to select one of these networks. If one of these networks is selected, the UE shall indicate the selected PLMN, wait until a new PLMN is detected, or new location areas or tracking areas of an allowed PLMN are found which are not in the forbidden LA or TA list(s), and then repeat the procedure.

If the registration cannot be achieved on any PLMN and no PLMN offering restricted local operator services is selected, the UE shall indicate “No Service”. The user may then select and attempt to register on another or the same PLMN following the above procedure. The UE shall not attempt to register on a PLMN which has not been selected by the user.

Once the UE has registered on a PLMN selected by the user, the UE shall not automatically register on a different PLMN unless:

i) The new PLMN is declared as an equivalent PLMN by the registered PLMN;

or,

ii) The user selects automatic mode.

If a PLMN is selected but the UE cannot register on it because registration is rejected with the cause “PLMN not allowed”, the UE shall add the PLMN to the “Forbidden PLMN” list (clause 3.2.2.4.1). The UE shall not re-attempt to register on that network unless the same PLMN is selected again by the user.

If a PLMN is selected but the UE cannot register for PS services on it because registration is rejected with the cause “GPRS services not allowed in this PLMN”, the UE shall not re-attempt to register for E-UTRAN or UTRAN PS or GERAN PS on that network. The PLMN is added to the list “Forbidden PLMN's for GPRS services”. The UE shall not re-attempt to register for E-UTRAN or UTRAN PS or GERAN PS on that network unless the same PLMN is selected again by the user. The reception of the cause “GPRS services not allowed in this PLMN”, does not affect the CS service.

For requirements to restrict the access of a UE to one or several specific RATs see section 7.1.

If a PLMN is selected but the UE cannot register on it for other reasons, the UE shall, upon detection of a new LA (not in a forbidden LA list) of the selected PLMN, attempt to register on the PLMN.

If the UE is registered on a PLMN but loses coverage, different (discontinuous) carrier search schemes may be used to minimize the time to find a new valid BCCH carrier and maintain battery life, e.g. by prioritizing the search in favour of BCCH carriers of the registered PLMN.

Since the current PLMN selection process does not consider the selection of the non-public network, the UE does not reach quickly the NPN to which it is subscribed.

In addition, the NPN technology currently under discussion has issues in that the NPN operation and the existing PLMN operation are separated, and thus the UE implements two network selection operations.

In addition, considering various network installations, it is difficult for a UE to determine which method to use.

In addition, if the NPN is not stand-alone, that is, to implement the network slicing, the UE should first select the existing PLMN.

### Embodiment 1

In order to solve the above problems, the present specification exemplifies the following method.

3.2.1 General

The UE shall support both manual and automatic network selection mechanisms (modes). The UE shall select the last mode used, as the default mode, at every switch-on.

As an optional feature of the ME, the user shall be able to set a preference in the ME for the mode that shall be used at switch on. If set then the ME shall select this preference rather than the default mode.

Note: By defaulting to the last mode used, e.g. manual network selection, the undesired automatic selection of an adjacent PLMN instead of the desired HPLMN in border areas, can be avoided at switch-on.

The user shall be given the opportunity to change mode at any time.

Except as defined below, the MMI shall be at the discretion of the UE manufacturer.

The UE shall contain display functions by which Available PLMNs and the Selected PLMN can be indicated.

In order not to confuse the user, the same definitions of PLMN names shall be applied consistently both in registered mode and in the list presented to the user when in manual mode.

In shared networks a radio access network can be part of more than one PLMN. This shall be transparent to the user, i.e. the UE shall be able to indicate those PLMNs to the user, and the UE shall support network selection among those PLMNs, as in non-shared networks.

3.2.2 Procedures

3.2.2.1 General

In the following procedures the UE selects and attempts registration on PLMNs.

In this TS, the term “PLMN Selection” defines a UE based procedure, whereby candidate PLMNs are chosen, one at a time, for attempted registration.

A User Controlled PLMN Selector data field exists on the USIM to allow the user to indicate a preference for network selection. It shall be possible for the user to update the User Controlled PLMN Selector data field, but it shall not be possible to update this data field over the radio interface, e.g. using SIM Application Toolkit.

It shall be possible to have an Operator Controlled PLMN Selector list and a User Controlled PLMN Selector list stored on the SIM/USIM card. Both PLMN Selector lists may contain a list of preferred PLMNs in priority order. It shall be possible to have an associated Access Technology identifier e.g., N G-RAN, E-UTRAN (WB-S1 mode), E-UTRAN(NB-S1 mode), UTRAN, GERAN or GERAN EC-GSM-IoT associated with each entry in the PLMN Selector lists. For the support of non public network, it shall be possible to have an associated identifier for non public network. I.e, PLMN selector list is extended to include NPN ID in addition to Access Technology identifier. Accordingly, each item of the PLMN selector list may include a PLMN name and associated RAT information, and additionally a non-public network id (NID). The UE attempts to select a network in the order of each item present in this list, and if there is an NID item in this process, it performs a network selection operation considering the item. Through this, network operation in consideration of the priority of the NPN in the PLMN selection process is possible. In addition, when the NPN is implemented as a network slice, or a non-public network without NID can be effectively selected.

The UE shall utilise all the information stored in the USIM related to network selection, e.g. HPLMN, Operator controlled PLMN Selector list, User Controlled PLMN Selector list, Forbidden PLMN list.

Note 1: A PLMN in a Selector list, including HPLMN, may have multiple occurrences, with different access technology identifiers and/or identifier for non public network.

The UE shall ignore those PLMN+access technology entries in the User Controlled PLMN selector and Operator Controlled PLMN selector lists where the associated Access Technology is not supported by the UE. In the case that there are multiple associated Access Technology identifiers in an entry the UE shall not ignore the entry if it includes any associated Access Technology that is supported by the UE.

It shall be possible to handle cases where one network operator accepts access from access networks with different network IDs. It shall also be possible to indicate to the UE that a group of PLMNs are equivalent to the registered PLMN regarding PLMN selection, cell selection/re-selection and handover.

It shall be possible for the home network operator to identify alternative Network IDs as the HPLMN. It shall be possible for the home network operator to store in the USIM an indication to the UE that a group of PLMNs are treated as the HPLMN regarding PLMN selection. Any PLMN to be declared as an equivalent to the HPLMN shall be present within the EHPLMN list and is called an EHPLMN. The EHPLMN list replaces the HPLMN derived from the IMSI. When the EHPLMN list is present, any PLMN in this list shall be treated as the HPLMN in all the network and cell selection procedures.

If registration on a PLMN is successful, the UE shall indicate this PLMN (the “registered PLMN”) and be capable of making and receiving calls on it. The identity of the registered PLMN shall be stored on the SIM/USIM. However, if registration is unsuccessful, the UE shall ensure that there is no registered PLMN stored in the SIM/USIM.

If a registration is unsuccessful because the IMSI is unknown in the home network, or the UE is illegal, then the UE shall not allow any further registration attempts on any network, until the UE is next powered-up or a SIM/USIM is inserted.

If the registration is unsuccessful due to the lack to service entitlement, specific behaviour by the UE may be required, see clause 3.2.2.4.

To avoid unnecessary registration attempts, lists of forbidden PLMNs, TAs and LAs are maintained in the UE, see clause 3.2.2.4 and 3GPP TS 23.122 [3].

Registration attempts shall not be made by UEs without a SIM/USIM inserted.

An UE/ME which has not successfully registered shall nevertheless be able to make emergency call attempts on an available PLMN (which supports the emergency call teleservice), without the need for the user to select a PLMN. An available PLMN is determined by radio characteristics (3GPP TS 23.122 [3]).

3.2.2.2 At switch-on or recovery from lack of coverage

At switch on, when in coverage of the last registered PLMN as stored in the SIM/USIM, the UE will attach to that network.

As an option, in automatic selection mode, when no EHPLMN list is present, the UE may select the HPLMN. When the EHPLMN list is present, the UE may select the highest priority EHPLMN among the available EHPLMNs. The operator shall be able to control the UE behaviour by USIM configuration.

As an option, if the UE is in manual network selection mode at switch-on

if the last registered PLMN is unavailable and no equivalent PLMN is available,

and the UE finds it is in coverage of either the HPLMN or an EHPLMN

then the UE should register on the corresponding HPLMN or EHPLMN. The UE remains in manual mode.

If the UE returns to coverage of the PLMN on which it is already registered (as indicated by the registered PLMN stored in the SIM/USIM), the UE shall perform a location update to a new location area if necessary. As an alternative option to this, if the UE is in automatic network selection mode and it finds coverage of the HPLMN or any EHPLMN, the UE may register on the HPLMN (if the EHPLMN list is not present) or the highest priority EHPLMN of the available EHPLMNs (if the EHPLMN list is present) and not return to the last registered PLMN. If the EHPLMN list is present and not empty, it shall be used. The operator shall be able to control by USIM configuration whether an UE that supports this option shall follow this alternative behaviour.

NOTE: At switch-on and at recovery from lack of coverage, a UE in automatic network selection mode can attempt registration once the RPLMN or, if the above option is applicable, the HPLMN or EHPLMN is found on an access technology.

The default behaviour for a UE is to select the last registered PLMN.

If there is no registered PLMN stored in the SIM/USIM, or if this PLMN is unavailable and no equivalent PLMN is available, or the attempted registration fails, the UE shall follow one of the following procedures for network selection:

A) Automatic network selection mode

The UE shall select and attempt registration on other PLMNs, if available and allowable, if the location area is not in the list of “forbidden LAs for roaming” and the tracking area is not in the list of “forbidden TAs for roaming” (see 3GPP TS 23.122 [3]), in the following order:

i) An EHPLMN if the EHPLMN list is present or the HPLMN (derived from the IMSI) if the EHPLMN list is not present for preferred access technologies in the order specified. In the case that there are multiple EHPLMNs present then the highest priority EHPLMN shall be selected. It shall be possible to configure a voice capable UE so that it shall not attempt registration on a PLMN if all cells identified as belonging to the PLMN do not support the corresponding voice service;

ii) each entry in the “User Controlled PLMN Selector with Access Technology” data field in the SIM/USIM (in priority order). It shall be possible to configure a voice capable UE so that it shall not attempt registration on a PLMN if all cells identified as belonging to the PLMN do not support the corresponding voice service;

iii) each entry in the “Operator Controlled PLMN Selector with Access Technology” data field in the SIM/USIM (in priority order). It shall be possible to configure a voice capable UE so that it shall not attempt registration on a PLMN if all cells identified as belonging to the PLMN do not support the corresponding voice service;

iv) other PLMN/access technology combinations with sufficient received signal quality (see 3GPP TS 23.122 [3]) in random order. It shall be possible to configure a voice capable UE so that it shall not attempt registration on a PLMN if all cells identified as belonging to the PLMN do not support the corresponding voice service;

v) all other PLMN/access technology combinations in order of decreasing signal quality. It shall be possible to configure a voice capable UE so that it shall not attempt registration on a PLMN if all cells identified as belonging to the PLMN do not support the corresponding voice service.

In the case of a UE operating in UE operation mode A or B, an allowable PLMN is one which is not in the “Forbidden PLMN” data field in the SIM/USIM. This data field may be extended in the ME memory (see clause 3.2.2.4). In the case of a UE operating in UE operation mode C, an allowable PLMN is one which is not in the “Forbidden PLMN” data field in the SIM/USIM or in the list of “forbidden PLMNs for GPRS service” in the ME.

If successful registration is achieved, the UE shall indicate the selected PLMN.

If registration cannot be achieved on any PLMN and at least one PLMN offering restricted local operator services has been found, the UE shall obtain user consent for restricted local operator services and the UE may use a list of preferred PLMNs for restricted local operator services stored in the ME. If none of the preferred PLMNs for restricted local operator services is available, the UE shall select any available PLMN offering restricted local operator services. If one of these PLMNs for restricted local operator service is chosen, the UE shall indicate the choice. If none are selected, the UE shall wait until a new PLMN is detected, or new location areas or tracking areas of an allowed PLMN are found which are not in the forbidden LA or TA list(s), and then repeat the procedure.

If registration cannot be achieved on any PLMN and no PLMN offering restricted local operator services has been found, the UE shall indicate “no service” to the user, wait until a new PLMN is detected, or new location areas or tracking areas of an allowed PLMN are found which are not in the forbidden LA or TA list(s), and then repeat the procedure. When registration cannot be achieved, different (discontinuous) PLMN search schemes may be used in order to minimize the access time while maintaining battery life, e.g. by prioritising the search in favour of BCCH carriers which have a high probability of belonging to an available and allowable PLMN.

B) Manual Network Selection Mode

The UE shall indicate PLMNs, including “Forbidden PLMNs”, which are available. If there are none, this shall also be indicated. The HPLMN of the user may provide on the USIM additional information about the available PLMNs, if this is provided then the UE shall indicate that information to the user. This information, provided as free text may include:

Preferred partner,

roaming agreement status,

supported services

Furthermore, the UE may indicate whether the available PLMNs are present on one of the PLMN selector lists (e.g. EHPLMN, User Controlled, Operator Controlled or Forbidden) as well as not being present on any of the lists.

For the purpose of presenting the names of the available PLMNs to the user, the ME shall use the USIM defined names if available or other PLMN naming rules in priority order as defined in 3GPP TS 22.101 [7] (Country/PLMN indication).

Any available PLMNs shall be presented in the following order:

i) HPLMN (if the EHPLMN list is not present); or if one or more of the EHPLMNs are available then based on an optional data field on the USIM either the highest priority available EHPLMN is to be presented to the user or all available EHPLMNs are presented to the user in priority order; if the data field is not present, then only the highest priority available EHPLMN is presented;

ii) PLMNs contained in the “User Controlled PLMN Selector” data field in the SIM/USIM (in priority order);

iii) PLMNs contained in the “Operator Controlled PLMN Selector” data field in the SIM/USIM (in priority order);

iv) other PLMN/access technology combinations with sufficient received signal level (see 3GPP TS 23.122 [3]) in random order;

v) all other PLMN/access technology combinations in order of decreasing signal strength.

If a PLMN does not support voice services then this shall be indicated to the user.

The user may select the desired PLMN and the UE shall attempt registration on this PLMN. (This may take place at any time during the presentation of P I LMNs.)

If registration cannot be achieved on any PLMN and at least one PLMN offering restricted local operator services has been found, the UE shall obtain user consent for restricted local operator services and offer the user to select one of these networks. If one of these networks is selected, the UE shall indicate the selected PLMN, wait until a new PLMN is detected, or new location areas or tracking areas of an allowed PLMN are found which are not in the forbidden LA or TA list(s), and then repeat the procedure.

If the registration cannot be achieved on any PLMN and no PLMN offering restricted local operator services is selected, the UE shall indicate “No Service”. The user may then select and attempt to register on another or the same PLMN following the above procedure. The UE shall not attempt to register on a PLMN which has not been selected by the user.

Once the UE has registered on a PLMN selected by the user, the UE shall not automatically register on a different PLMN unless:

i) The new PLMN is declared as an equivalent PLMN by the registered PLMN;

or,

ii) The user selects automatic mode.

If a PLMN is selected but the UE cannot register on it because registration is rejected with the cause “PLMN not allowed”, the UE shall add the PLMN to the “Forbidden PLMN” list (clause 3.2.2.4.1). The UE shall not re-attempt to register on that network unless the same PLMN is selected again by the user.

If a PLMN is selected but the UE cannot register for PS services on it because registration is rejected with the cause “GPRS services not allowed in this PLMN”, the UE shall not re-attempt to register for E-UTRAN or UTRAN PS or GERAN PS on that network. The PLMN is added to the list “Forbidden PLMN's for GPRS services”. The UE shall not re-attempt to register for E-UTRAN or UTRAN PS or GERAN PS on that network unless the same PLMN is selected again by the user. The reception of the cause “GPRS services not allowed in this PLMN”, does not affect the CS service.

For requirements to restrict the access of a UE to one or several specific RATs see section 7.1.

If a PLMN is selected but the UE cannot register on it for other reasons, the UE shall, upon detection of a new LA (not in a forbidden LA list) of the selected PLMN, attempt to register on the PLMN.

If the UE is registered on a PLMN but loses coverage, different (discontinuous) carrier search schemes may be used to minimize the time to find a new valid BCCH carrier and maintain battery life, e.g. by prioritizing the search in favour of BCCH carriers of the registered PLMN.

### Embodiment 2

Another method exemplified in the present specification may separate a network selection process for NPN and a network selection of an existing PLMN, and may also efficiently support NPN implemented as a network slice in network selection process for NPN.

To this end, a network operator, a user may or the like store information on the NPN subscribed to the UE and additionally store whether the NPN is a stand-alone network or implemented as a network slice for each NPN. For example, information may be set through a SIM card of the UE, an OMA DM process, or a registration process. Then, when the user selects the NPN, if the standalone NPN is selected, the network selection process for the NPN is performed. If the user selects the NPN implemented as a network slice in the non-standalone NPN, PLMN, or the like, the existing PLMN selection can be performed.

In connection with the contents of the second embodiment and the contents of the first embodiment, if the PLMN list additionally includes the content of the NPN, the PLMN list may include information on whether the NPN is non-standalone or stand-alone through a scheme such as a network slice or a closed access group (CAG). Accordingly, the UE may perform network selection in the order shown in the PLMN list. If an item is an NPN and the non-standalone, the UE may attempt to select a PLMN. If the stand-alone NPN, the UE may perform a dedicated network selection process for the NPN.

### Embodiment 3

As another embodiment of the present specification, the service provider or the telecommunication service provider additionally sets information on which region the NPN is valid in, in the process of setting network information to the UE and in the procees of adding a setting for the NPN. Based on this, the UE searches for an NPN when entering or is located in the area, or performs a network selection operation for the NPN, and performs an existing PLMN search operation outside the area.

Since NPN is a network for a specific small user, the area of service provision is smaller than that of a conventional carrier (PLMN) that provides service in a wide range of areas. In this case, the UE subscribed only to the NPN is provided with the communication service only in the region where the NPN is located. In a region other than the NPN, the process of searching for the NPN network may increase battery consumption of the UE.

Therefore, in the present specification, for each NPN, the UE is provided with information on a region where each NPN is installed or valid, and based on this, it is checked whether the NPN is valid in its current region or which NPN the UE itself is subscribed to. If the UE determines that there is a valid NPN in its current region or the UE itself is subscribed to, the UE may start searching for a valid NPN through the cell search or the like. If it is determined that the UE is valid in the region where it is located or there is no NPN subscribed to, the UE may omit a process such as cell search. The information may be stored in the SIM card of the UE or the memory of the UE.

If the NPN is a non-standalone NPN implemented on the PLMN, the UE may first search for the PLMN. Therefore, in this case, even if the UE is located in any region, the PLMN can be searched. Therefore, in order to use the method more effectively, the operation may be limited to the case where the NPN selected by the UE is a stand-alone scheme.

Whether which NPN is non-standalone or not may be used in the scheme described in Example 2. The method described in the first embodiment may be used to select depending on which rank, or the valid NPN in which region is valid.

This process may be further limited when the UE subscribes only to the NPN and does not subscribe to the PLMN.

### Embodiment 4

The following is an example operation based on the above contents. The following operation can be applied when the NPN is both in standalone and non-standalne mode.

Table 2 is an example of a PLMN selector list to which the present specification can be applied.

TABLE 2

| Priority | PLMN ID | NPN ID (e.g, CAG ID) |
|---|---|---|
| 0 | A | SNPN ID = A |
| 1 | B | CAG ID = B |
| 2 | B | CAG ID = C |
| 3 | C | CAG ID = D |

Referring to Table 2, the PLMN selector list illustrates an extension according to the present specification. Here, PLMN B and PLMN C provide NPN services in a non-standalone manner, and standalone NPN may be set to SNPN ID A. Alternatively, the CAG ID list can be organized into a separate table.

In more detail, PLMN B can provide NPN services in a non-standalone manner. The PLMN B may provide two CAG IDs, that is, an NPN set to CAG ID B and an NPN set to CAG ID C. In addition, the NPN set to CAG ID B may have priority over the NPN set to CAG ID C.

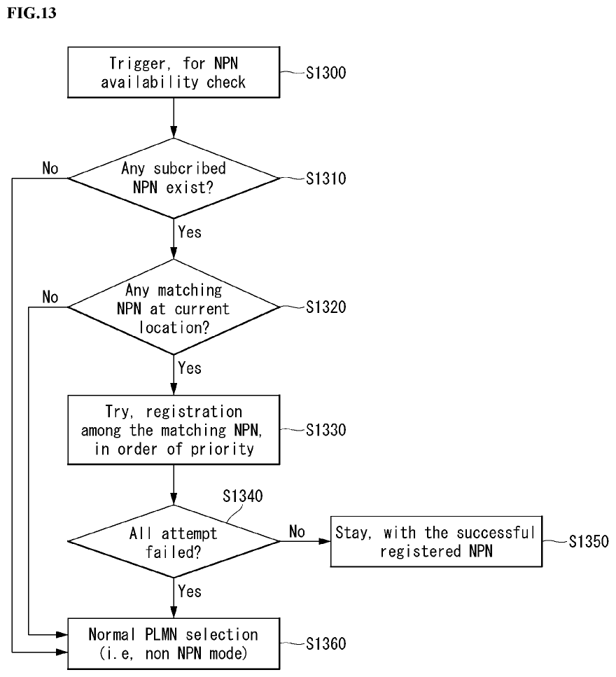

FIG. 12 is an embodiment of a UE to which the present specification can be applied.

Referring to FIG. 12, when a condition such as being powered on or moving to a new region is satisfied, the UE starts the NPN selection process (S1200).

The UE checks whether there is a PLMN/NPN related list, and selects from the highest item among the items which have not been attempted (S1210).

The UE performs a registration process (S1220). For example, the UE attempts a registration process using an item selected through S1210, that is, PLMN information and NPN information.

The UE checks whether to succeed in the registration process (S1230). In more detail, if the registration process of the UE is successful, the UE may transition to S1240, and if it fails, it may transition to S1250.

The UE checks the last attempted PLMN and NPN information, informs the user that the service has registered in the NPN, and ends the process (S1240).

The UE checks whether there is another CAG ID which is not attempted at the currently selected PLMN (S1250).

If there is no CAG ID remaining in the currently selected PLMN, the UE selects the next item from the pLMN list (S1260). For example, the PLMN of the following items can be selected. Thereafter, the UE may transition to S1220. In more detail, when the UE transitions to S1220, the UE may select the highest position item, that is, the highest priority item, with respect to the selected PLMN.

The UE selects, from the currently selected PLMN, the unattempted CAG ID, among the CAG IDs applicable to the currently selected PLMN (S1260). Thereafter, the UE may transition to S1220. In more detail, the UE may attempt to subscribe to the highest priority item among the remaining CAG Ids, with respect to the currently selected PLMN.

Table 3 is an example of an extended PLMN selector list to which the present specification can be applied.

TABLE 3

| Priority | NPN ID | Area |
|---|---|---|
| 0 | SNPN A | A1 |
| 1 | CAG B | B1 |
| 2 | CAG B | A1 |
| 3 | CAG C | D1 |

FIG. 13 is an embodiment of a UE to which the present specification can be applied.

Referring to FIG. 13, the UE starts an NPN selection process (S1300). For example, the UE may trigger the NPN selection process, resulted from the movement of the UE, periodic re-search, or discovery of a new cell.

The UE checks whether there is an NPN subscribed thereto (S1310).

If the UE is subscribed to the NPN, the UE determines a valid NPN in the region where the current UE is located (S1320). For example, in the NPN information or the PLMN list stored in the UE, the UE may check valid location information for each NPN. In addition, the UE may determine the information of the current region by GPS, or cell information, TA information, and based on this, it is possible to extract the valid in the current region among the NPN.

The UE attempts to subscribe, according to the priority of the NPN valid in the current region, using the result of S1320 (S1330).

The UE determines whether registration attempts for all valid NPNs in the current region have failed (S1340). If all fail, the UE may transition to S1360. Alternatively, if any one of them succeeds, the UE may transition to S1350.

The UE is provided with the service for the successful NPN, and ends the process (S1350).

Since there is no available NPN, the UE performs a general PLMN selection process (S1360).

In the present specification, a message name, a message format, a name of an information element, a format of an information element, and the like are examples. Their names, included locations, or types of messages used can be variously applied and modified.

The present specification may be variously applied to a 5G system, a 4G system, and the like.

As a result of the present specification, when a UE subscribes to several NPNs, the UE attempts to access to the NPN having a high priority. As a result, each UE first accesses an NPN configured suitable to its data characteristics.

In addition, the additional effect of the present specification, because the UE attempts to select only the NPN available in the current region by using the region information, it can prevent the UE from attempting to access the NPN unnecessarily in the region where the NPN is not installed. As a result, the UE saves power, and the network can avoid unnecessary access from the UE.

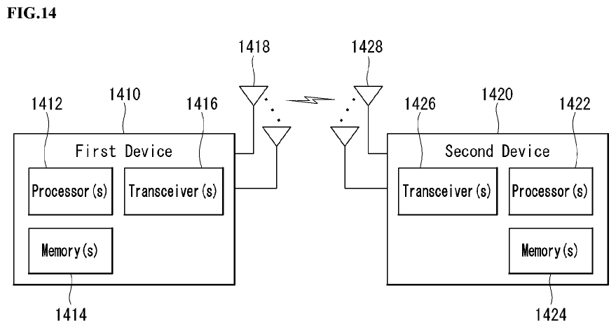

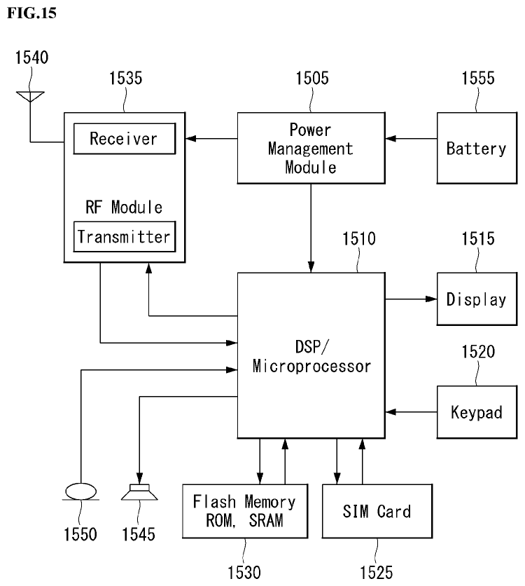

FIG. 14 illustrates a block configuration diagram of a communication device according to an embodiment of the present disclosure.

Referring to FIG. 14, the wireless communication system includes a network node 1410 and a plurality of terminals (UEs) 1420.

The network node 1410 includes a processor 1411, a memory 1412, and a communication module (transceiver) 1413. The processor 1411 implements the functions, the processes, and/or the methods described above with reference to in FIGS. 1 to 13. The layers of the wired/radio interface protocol may be implemented by the processor 1411.

The memory 1412 is connected to the processor 1411 and stores various information for driving the processor 1411. The communication module 1413 is connected to the processor 1411 and transmits and/or receives a wired/wireless signal. Examples of the network node 1410 may include a base station, an AMF, an SMF, a UDF, or the like. In particular, when the network node 1410 is the base station, the communication module 1413 may include a radio frequency unit (RF) for transmitting/receiving the wireless signal.

The terminal 1420 includes a processor 1421, a memory 1422, and a communication module (transceiver) 1423. The processor 1421 implements the functions, the processes, and/or the methods described above with reference to FIGS. 1 to 16. The layers of the radio interface protocol may be implemented by the processor 1421. In particular, the processor may include a NAS layer and an AS layer. The memory 1422 is connected to the processor 1421 and stores various information for driving the processor 1421. The communication module 1423 is connected to the processor 1421 and transmits and/or receives the wireless signal.

The memories 1412 and 1422 may be inside or outside the processors 1411 and 1421 and may be connected to the processors 1411 and 1421 by various well-known means. Also, the network node 1410 (in the case of the base station) and/or the terminal 1420 may include a single antenna or multiple antennas.

FIG. 15 illustrates a block configuration diagram of a communication device according to an embodiment of the present disclosure.

In particular, FIG. 15 is a diagram illustrating the terminal of FIG. 14 in more detail. The communication module illustrated in FIG. 15 includes an RF module (or RF unit) of FIG. 14. The processor illustrated in FIG. 14 corresponds to a processor (or a digital signal processor (DSP) 1510) in FIG. 15. The memory illustrated in FIG. 14 corresponds to a memory 1530 of FIG. 15.

Referring to FIG. 15, a terminal may be configured to include a processor (or a digital signal processor (DSP)) 1510, an RF module (or RF unit) 1535, a power management module 1505, an antenna 1540, a battery 1555, a display 1515, a keypad 1515, a memory 1530, a subscriber identification module (SIM) card 1525 (this configuration is optional), a speaker 1545, and a microphone 1550. The terminal may also include a single antenna or multiple antennas.

The processor 1510 implements the functions, the processes and/or the methods described above. The layers of the radio interface protocol may be implemented by the processor 1510.

The memory 1530 is connected to the processor 1510 and stores various information related to an operation of the processor 1510. The memory 1530 may be inside or outside the processors 1510 and 1921 and may be connected to the processor 1510 by various well-known means.

The user inputs command information such as a telephone number, for example, by pressing (or touching) a button on the keypad 1515 or by voice activation using the microphone 1550. The processor 1510 receives the command information and performs a proper function as placing a call by a phone number. Operational data may be extracted from the SIM card 1525 or the memory 1530. In addition, the processor 1510 may display command information or driving information on the display 1515 for the user to recognize and for convenience.

The RF unit 1535 is connected to the processor 1510 and transmits and/or receives an RF signal. The processor 1510 transmits command information to the RF module 1535 to transmit, for example, a wireless signal constituting voice communication data to initiate communication. The RF module 1535 includes a receiver and a transmitter for receiving and transmitting a wireless signal. The antenna 1540 functions to transmit and receive the wireless signal. When receiving the wireless signal, the RF module 1535 may transmit a signal and convert the signal into baseband to be processed by the processor 1510. The processed signal may be converted into audible or readable information output through the speaker 1545.

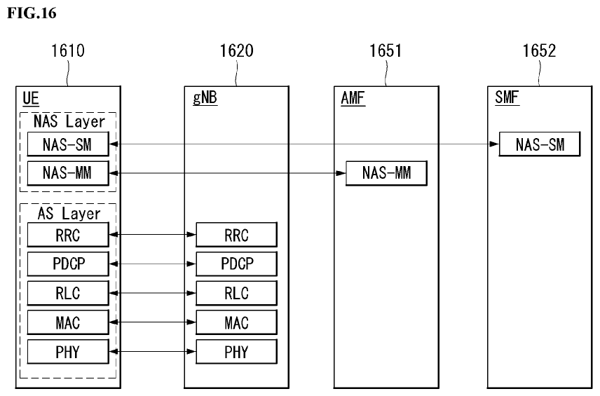

FIG. 16 illustrates a structure of a radio interface protocol in a control plane between a UE and eNodeB.

The radio interface protocol is based on the 3GPP radio access network standard. The radio interface protocol is composed of a physical layer (physical layer), a data link layer (data link layer) and a network layer (network layer) horizontally, and is vertically divided into a user plane for data information transmission and a control plane for signaling transmission.

The protocol layers are based on a lower three layers of a open system interconnection (OSI) reference model, which is widely known in communication systems, and may be divided into L1 (first layer), L2 (second layer), and L3 (third layer).

Hereinafter, each layer of the radio protocol of the control plane illustrated in FIG. 16 will be described.

The physical layer, which is the first layer, provides an information transfer service using a physical channel. The physical layer is connected to a medium access control layer on the upper side through a transport channel, and data between the medium access control layer and the physical layer is transmitted through the transport channel. In addition, data is transferred between different physical layers, that is, between physical layers of a transmitting side and a receiving side through a physical channel.

The physical channel is composed of several subframes on a time axis and several sub-carriers on a frequency axis. Here, one subframe is composed of a plurality of symbols and a plurality of subcarriers on the time axis. One subframe is composed of a plurality of resource blocks, and one resource block is composed of a plurality of symbols and a plurality of subcarriers. The transmission time interval (TTI), which is a unit time for transmitting data, is 1 ms corresponding to one subframe.

According to 3GPP LTE, the physical channels present in the physical layer of the transmitting side and the receiving side may be divided into a physical downlink shared channel (PDSCH) and a physical uplink shared channel (PUSCH) which are data channels, and a physical downlink control channel (PDCCH), a physical control format indicator channel (PCFICH), a physical hybrid-ARQ indicator channel (PHICH), and a physical uplink control channel (PUCCH) which are control channels.

The PCFICH transmitted in a first OFDM symbol of a subframe carries a control format indicator (CFI) regarding the number of OFDM symbols (that is, the size of the control region) used for transmission of control channels in the subframe. The wireless device first receives the CFI on the PCFICH and then monitors the PDCCH.

Unlike the PDCCH, the PCFICH does not use blind decoding and is transmitted on a fixed PCFICH resource of a subframe.

The PHICH carries a positive-acknowledgement (ACK)/negative-acknowledgement (NACK) signal for a UL hybrid automatic repeat request (HARQ). The ACK/NACK signal for uplink (UL) data on the PUSCH transmitted by the wireless device is transmitted on the PHICH.

The physical broadcast channel (PBCH) is transmitted in preceding four OFDM symbols of a second slot of a first subframe of the radio frame. The PBCH carries system information necessary for the wireless device to communicate with the base station, and the system information transmitted through the PBCH is called a master information block (MIB). In comparison, the system information transmitted on the PDSCH indicated by the PDCCH is called a system information block (SIB).

The PDCCH may carry resource allocation of an upper layer control message such as a resource allocation and transmission format of a downlink-shared channel (DL-SCH), resource allocation information of an uplink shared channel (UL-SCH), paging information on a PCH, system information on the DL-SCH, and a random access response transmitted on the PDSCH, an aggregation of transmission power control commands for individual UEs in a UE group, activation of a voice over internet protocol (VoIP), and the like. A plurality of PDCCHs may be transmitted in the control region, and the terminal may monitor the plurality of PDCCHs. The PDCCH is transmitted on an aggregation of one or several consecutive control channel elements (CCEs). The CCE is a logical allocation unit used to provide a PDCCH with a coding rate according to a state of a radio channel. The CCE corresponds to a plurality of resource element groups. The format of the PDCCH and the number of bits of the allowed PDCCH are determined according to the correlation between the number of CCEs and the coding rate provided by the CCEs.

The control information transmitted through the PDCCH is called downlink control information (DCI). The DCI may include the resource allocation (referred to as DL grant) of the PDSCH, the resource allocation (referred to as UL grant) of the PUSCH, and an aggregation of transmit power control commands for individual UEs in any UE group and/or activation of the voice over internet protocol (VoIP).

There are several layers in the second layer. First, a medium access control (MAC) layer is responsible for mapping various logical channels to various transport channels, and also for logical channel multiplexing to map multiple logical channels to one transport channel. The MAC layer is connected to an RLC layer as an upper layer by a logical channel, and the logical channel is largely divided into a control channel that transmits information of a control plane according to the type of information to be transmitted and a traffic channel that transmits user plane information.

A radio link control (RLC) layer of the second layer serves to adjust the data size so that the lower layer is suitable for transmitting data to the radio section by segmenting and concatenating data received from the upper layer. In addition, three operation modes of a transparent mode (TM), an un-acknowledged mode (UM) (non-response mode), and an acknowledged mode (AM) (response mode) are provided to ensure various QoS required by each radio bearer (RB). In particular, the AM RLC performs a retransmission function through an automatic repeat and request (ARQ) function for reliable data transmission.

A packet data convergence protocol (PDCP) layer of the second layer performs a header compression function of reducing an IP packet header size having a relatively larger size and unnecessary control information for efficient transmission in a radio section having a low bandwidth when transmitting IP packets such as IPv4 or IPv6. This transmits only the necessary information in the header portion of the data, thereby increasing the transmission efficiency of the radio section. In addition, in the LTE system, the PDCP layer also performs a security function, which is composed of encryption (Ciphering) for preventing third-party data interception and integrity protection for preventing third-party data manipulation.

The radio resource control layer (hereinafter abbreviated as RRC) layer located at the top of the third layer is defined only in the control plane, and serves to control the logical channels, the transport channels, and the physical channels in connection with the setting, resetting, and release of the radio bearers (abbreviated as RB). In this case, the RB means a service provided by the second layer for data transmission between the terminal and the E-UTRAN.

If there is an RRC connection (RRC connection) between the RRC of the terminal and the RRC layer of the radio network, the terminal is in the RRC connected state (connected mode), and otherwise, the terminal is in the RRC idle state (Idle mode).

Hereinafter, the RRC state and the RRC connection method of the UE will be described. The RRC state refers to whether or not the RRC of the terminal is logically connected with the RRC of the E-UTRAN. The case where the RRC of the terminal is logically connected with the RRC of the E-UTRAN is referred to as the RRC_CONNECTED state, and the case where the RRC of the terminal is not logically connected with the RRC of the E-UTRAN is referred to as the RRC_IDLE state. Since the terminal in the RRC_CONNECTED state has an RRC connection, the E-UTRAN can detect the existence of the corresponding terminal in units of cells, thereby effectively controlling the terminal. On the other hand, the terminal in the RRC_IDLE state cannot detect the existence of the terminal by the E-UTRAN, and manages the core network in a tracking area (TA) unit which is a larger area unit than the cell. That is, the terminal in the RRC_IDLE state only detects whether the terminal exists in a larger area than the cell, and the terminal needs to transition to the RRC_CONNECTED state in order to receive a normal mobile communication service such as voice or data. Each TA is identified by a tracking area identity (TAI). The terminal may configure a TAI through a tracking area code (TAC), which is information broadcast in a cell.

When the user first turns on the power of the terminal, the terminal first searches for an appropriate cell, then establishes an RRC connection in the cell, and registers the terminal's information in the core network. Thereafter, the terminal stays in the RRC_IDLE state. The terminal staying in the RRC_IDLE state (re) selects a cell as needed and looks at system information or paging information. This is called camping on the cell. When it is necessary to establish an RRC connection, the terminal staying in the RRC_IDLE state makes an RRC connection with the RRC of the E-UTRAN through an RRC connection procedure and transitions to the RRC_CONNECTED state. There are several cases in which the terminal in the RRC_IDLE state needs to establish the RRC connection. For example, when an uplink data transmission is necessary due to a user's call attempt, or when the paging signal is received from the E-UTRAN, there may be a response message transmission thereto, and the like.

The non-access stratum (NAS) layer performs functions such as session management and mobility management.

The following describes the NAS layer shown in FIG. 16 in detail.

The NAS layer is divided into a NAS entity for mobility management (MM) and a

NAS entity for session management (SM).

1) The NAS entity for MM provides the following general functions.

The NAS procedure associated with the AMF includes the followings.

Registration management and access management procedure. The AMF supports the following functions.

NAS signal connection (integrity protection, encryption) between the UE and the AMF

2) The NAS entity for the SM performs the session management between the UE and the SMF.

The SM signaling message are processed, i.e., generated and processed, at the NAS-SM layer of the UE and the SMF. The content of the SM signaling message is not interpreted by the AMF.

For the SM signaling transmission

The NAS entity for the MM generates a security header indicating the NAS transmission of SM signaling and a NAS-MM message that guides a method and a location for transferring an SM signaling message through additional information on the received NAS-MM.

Upon receiving the SM signaling, the NAS entity for the SM performs an integrity check of the NAS-MM message and a method and a location for interpreting additional information to derive an SM signaling message.

Meanwhile, in FIG. 16, the RRC layer, the RLC layer, the MAC layer, and the PHY layer located under the NAS layer are collectively referred to as an access stratum (AS).

In the present disclosure, a wireless device includes a base station, a network node, a transmitting terminal, a receiving terminal, a wireless device, a wireless communication device, a vehicle, a vehicle equipped with a self-driving function, an unmanned aerial vehicle (UAV), an artificial intelligence (AI) module, a robot, an augmented reality (AR) device, a virtual reality (VR) device, an MTC device, an IoT device, a medical device, a fintech device (or financial device), a security device, a climate/environmental device, or other fourth-order industrial revolution fields, devices associated with a 5G service, or the like. For example, the drone can be a vehicle flying by radio control signals without people. For example, the MTC device and the IoT device are devices that do not require human intervention or manipulation, and may be a smart meter, a bending machine, a thermometer, a smart bulb, a door lock, various sensors, and the like. For example, the medical device is a device used to examine, replace, or modify a device, a structure, or a function used for diagnosing, treating, alleviating, treating, or preventing a disease, and may be a medical device, a surgical device, a (in vitro) diagnostic device, a hearing aid, a surgical operation device, and the like. For example, the security device is a device installed to prevent a risk that may occur and maintain safety, and may be a camera, a CCTV, a black box, or the like. For example, the fintech device is a device that can provide financial services such as mobile payment, and may be a payment device or a point of sales (POS). For example, the climate/environmental device may mean a device for monitoring and predicting the climate/environment.

The mobile terminal described in the present disclosure may include a mobile phone, a smart phones, a laptop computer, a digital broadcasting terminal, personal digital assistants (PDA), a portable multimedia player, navigation, a slate PC, a tablet PC, an ultrabook, a wearable device (e.g., smartwatch, smart glass, head mounted display), and the like. Furthermore, the mobile device may be used for controlling at least one device in an IoT (Internet of Things) environment or a smart greenhouse.

However, those skilled in the art can easily understand that the configuration according to the embodiment described in the present disclosure may also apply to the fixed terminal such as digital TV, desktop computer, digital signage, etc., except that the case where it is applied only to the mobile terminal.

In the above, embodiments associated with the control method that can be implemented in the mobile terminal configured as described above have been described with reference to the accompanying drawings. It will be apparent to those skilled in the art that the present disclosure may be embodied in other specific forms without departing from the spirit and essential characteristics of the present disclosure.

Embodiments of the present disclosure described above may be implemented through various means. For example, embodiments of the present disclosure may be implemented by hardware, firmware, software, a combination thereof, or the like.

In the case in which the embodiment of the present disclosure is implemented by the hardware, the method according to the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the case of implementation by firmware or software, the method according to the embodiments of the present disclosure may be implemented in the form of an apparatus, a procedure, a function, or the like for performing the functions or operations described above. A software code may be stored in a memory unit and be driven by a processor. The memory unit may be positioned inside or outside the processor and transmit and receive data to and from the processor by various well-known means.

The present disclosure described above permits the program to be embodied as computer readable code on a medium on which the program is recorded. A computer readable medium may include all kinds of recording devices in which data that may be read by a computer system are stored. An example of the computer readable medium may include a hard disk drive (HDD), a solid state disk (SSD), a silicon disk drive (SDD), an ROM, an RAM, a CD-ROM, a magnetic tape, a floppy disk, a floppy disk, an optical data storage device, or the like, and also include media implemented in a form of a carrier wave (for example, transmission through the Internet). In addition, the computer may also include a processor Y120 of the terminal. Therefore, the above-mentioned detailed description is to be interpreted as being illustrative rather than being restrictive in all aspects. The scope of the present disclosure should be determined by reasonable interpretation of the appended claims, and all changes within the equivalent scope of the present disclosure are included in the scope of the present disclosure.

The communication method as described above may be applied to not only 3GPP systems but also various wireless communication systems including IEEE 802.16x and 802.11x systems. Furthermore, the proposed method may be applied to mmWave communication system using ultra high frequency band.

What is claimed is:

1. A method for a user equipment (UE) to select a non-public network (NPN) in a wireless communication system, the method comprising the steps of:
selecting a network based on a network selection list stored in the UE or an USIM of the UE, the network selection list including (i) a PLMN identifier (ii) or the PLMN identifier and an NPN identifier;
when the network selection list includes the PLMN identifier and the NPN identifier and the selected network is an NPN associated with the NPN identifier, transmitting a registration request message to the NPN; and
receiving a registration response message from the NPN in response to the registration request message.

2. The method of claim 1, wherein the selected network is a network having the highest priority based on a network which has not attempted registration included in the network selection list.

3. The method of claim 2, wherein in the network selection list, (i) the PLMN identifier (ii) or the PLMN identifier and the NPN identifier are aligned based on the priority.

4. The method of claim 1, wherein the network selection list is a PLMN selector list.

5. The method of claim 1, wherein the network selection list further comprises radio access technology (RAT) information of a network associated with (i) the PLMN identifier (ii) or the PLMN identifier and the NPN identifier.

6. The method of claim 4, further comprising:
selecting a PLMN associated with the PLMN identifier when the selected item includes only the PLMN identifier, based on the network selection list;
transmitting a registration request message to the PLMN; and
receiving a registration response message from the PLMN in response to the registration request message.

7. The method of claim 1, wherein the network selection list further includes location information in which the NPN associated with the NPN identifier is valid.

8. The method of claim 7, wherein the selecting the network is performed when the current location of the UE is in a valid region where an NPN associated with the NPN identifier is available, based on the network selection list including the PLMN identifier and the NPN identifier.

9. The method of claim 8, wherein the current location of the UE is determined using the tracking area (TA) information, cell information or GPS coordinate information set in the UE.

10. The method of claim 9, further comprising:
performing a PLMN selection process based on absence of the selected network;
transmitting a registration request message to the selected PLMN; and
receiving, from the selected PLMN, a registration response message as a response to the registration request.

11. A user equipment (UE) performing a method to select a non-public network (NPN) in a wireless communication system, comprising:
a transceiver;
a USIM;
a memory; and
a processor configured to control the transceiver and the memory, the processor further configured to:
select a network based on a network selection list stored in the memory or an USIM, the network selection list including (i) a PLMN identifier (ii) or the PLMN identifier and an NPN identifier;
when the network selection list includes the PLMN identifier and the NPN identifier and the selected network is an NPN associated with the NPN identifier, transmit a registration request message to the NPN through the transceiver, and receive a registration response message from the NPN in response to the registration request message.

12. The UE of claim 11, wherein the selected network is a network having the highest priority based on a network which has not attempted registration included in the network selection list.

13. The UE of claim 12, wherein in the network selection list, (i) the PLMN identifier (ii) or the PLMN identifier and the NPN identifier are aligned based on the priority.

14. The UE of claim 11, wherein the network selection list is a PLMN selector list.

15. The UE of claim 11, wherein the network selection list further comprises radio access technology (RAT) information of a network associated with (i) the PLMN identifier (ii) or the PLMN identifier and the NPN identifier.

16. The UE of claim 14, wherein the processor further configured to:
select PLMN associated with the PLMN identifier when the selected item includes only the PLMN identifier, based on the network selection list;
transmit a registration request message to the PLMN and receive a registration response message from the PLMN in response to the registration request message, through the transceiver.

17. The UE of claim 11, wherein the network selection list further includes location information in which the NPN associated with the NPN identifier is valid.

18. The UE of claim 17, wherein the processor further configured to select the network when the current location of the UE is in a valid region where an NPN associated with the NPN identifier is available, based on the network selection list including the PLMN identifier and the NPN identifier.

19. The UE of claim 18, wherein the current location of the UE is determined using the tracking area (TA) information, cell information or GPS coordinate information set in the UE.

20. The UE of claim 19, wherein the processor further configured to:
perform a PLMN selection process based on absence of the selected network;
transmit a registration request message to the selected PLMN, and receive, from the selected PLMN, a registration response message as a response to the registration request, through the transceiver.
